(19) United States
(12) Patent Application Publication
(10) Pub. No.: US 2025/0350439 A1
(43) Pub. Date: Nov. 13, 2025

(54) TECHNIQUES FOR RESOLVING SUB-BAND FULL-DUPLEX (SBFD) TIME DOMAIN COLLISIONS

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US)

(21) Appl. No.: 18/656,857

(22) Filed: May 7, 2024

(51) Int. Cl. H04L 5/14

(52) U.S. Cl. CPC H04L 5/1438

(57) ABSTRACT

Methods, systems, and devices for wireless communications are described. In some cases, a sub-band full-duplex (SBFD)-aware user equipment (UE) may receive one or more control messages scheduling one or more downlink messages during an SBFD symbol and one or more uplink messages during the SBFD symbol, where the one or more downlink messages at least partially overlap with the one or more uplink messages in time, resulting in an SBFD time domain collision. In such cases, the UE may communicate, via the SBFD symbol, the one or more downlink messages or the one or more uplink messages in accordance with one or more SBFD collision rules.

### FIELD OF TECHNOLOGY

The following relates to wireless communications, including techniques for resolving sub-band full-duplex (SBFD) time domain collisions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a half-duplex UE is described. The method may include receive a configuration message indicating one or more SBFD symbols for a network entity, where each SBFD symbol of the one or more SBFD symbols includes one or more uplink sub-bands and one or more downlink sub-bands, receiving one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time, and communicating, via the SBFD symbol, the one or more downlink messages or the one or more uplink messages in accordance with one or more SBFD collision rules.

A half-duplex UE for wireless communications is described. The half-duplex UE may include one or more memories storing processor executable code, and one or more processors coupled with the one or more memories. The one or more processors may individually or collectively be operable to execute the code to cause the half-duplex UE to receive a configuration message indicating one or more SBFD symbols for a network entity, where each SBFD symbol of the one or more SBFD symbols includes one or more uplink sub-bands and one or more downlink sub-bands, receive one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time, and communicate, via the SBFD symbol, the one or more downlink messages or the one or more uplink messages in accordance with one or more SBFD collision rules.

Another half-duplex UE for wireless communications is described. The half-duplex UE may include means for receive a configuration message indicating one or more SBFD symbols for a network entity, where each SBFD symbol of the one or more SBFD symbols includes one or more uplink sub-bands and one or more downlink sub-bands, means for receiving one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time, and means for communicating, via the SBFD symbol, the one or more downlink messages or the one or more uplink messages in accordance with one or more SBFD collision rules.

A non-transitory computer-readable medium storing code for wireless communications is described. The code may include instructions executable by one or more processors to receive a configuration message indicating one or more SBFD symbols for a network entity, where each SBFD symbol of the one or more SBFD symbols includes one or more uplink sub-bands and one or more downlink sub-bands, receive one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time, and communicate, via the SBFD symbol, the one or more downlink messages or the one or more uplink messages in accordance with one or more SBFD collision rules.

In some examples of the method, half-duplex UEs, and non-transitory computer-readable medium described herein, communicating the one or more downlink messages or the one or more uplink messages may include operations, features, means, or instructions for receiving the one or more downlink messages based on the one or more SBFD collision rules indicating for the UE to prioritize the one or more downlink messages and transmitting the one or more uplink messages based on the one or more SBFD collision rules indicating for the UE to prioritize the one or more uplink messages.

In some examples of the method, half-duplex UEs, and non-transitory computer-readable medium described herein, both the one or more downlink messages and the one or more uplink messages may be semi-statically configured.

In some examples of the method, half-duplex UEs, and non-transitory computer-readable medium described herein, the one or more downlink messages include one or more synchronization signal block reference signals and the one or more uplink messages may be dynamically scheduled or semi-statically configured or semi-persistently configured.

In some examples of the method, half-duplex UEs, and non-transitory computer-readable medium described herein, the one or more downlink messages may be dynamically scheduled or semi-statically configured or semi-persistently configured and the one or more uplink messages may be associated with one or more random access occasions.

In some examples of the method, half-duplex UEs, and non-transitory computer-readable medium described herein, communicating the one or more downlink messages or the one or more uplink messages may include operations, features, means, or instructions for communicating the one or more downlink messages or the one or more uplink messages based on whether the SBFD symbol may be configured on the downlink symbol or on the flexible symbol.

In some examples of the method, half-duplex UEs, and non-transitory computer-readable medium described herein, communicating the one or more downlink messages or the one or more uplink messages may include operations, features, means, or instructions for receiving the one or more downlink messages based on the SBFD symbol being configured on the downlink symbol and transmitting the one or more uplink messages based on the SBFD symbol being configured on the flexible symbol.

In some examples of the method, half-duplex UEs, and non-transitory computer-readable medium described herein, communicating the one or more downlink messages or the one or more uplink messages may include operations, features, means, or instructions for communicating the one or more downlink messages or the one or more uplink messages based on whether the one or more downlink messages or the one or more uplink messages includes the flag.

In some examples of the method, half-duplex UEs, and non-transitory computer-readable medium described herein, communicating the one or more downlink messages or the one or more uplink messages may include operations, features, means, or instructions for receiving the one or more downlink messages based on the one or more downlink messages including the flag and transmitting the one or more uplink messages based on the one or more uplink messages including the flag.

In some examples of the method, half-duplex UEs, and non-transitory computer-readable medium described herein, communicating the one or more downlink messages or the one or more uplink messages may include operations, features, means, or instructions for communicating the one or more downlink messages or the one or more uplink messages based on whether the one or more downlink messages or the one or more uplink messages may be associated with the higher priority.

In some examples of the method, half-duplex UEs, and non-transitory computer-readable medium described herein, communicating the one or more downlink messages or the one or more uplink messages may include operations, features, means, or instructions for receiving the one or more downlink messages based on the first priority being greater than the second priority and transmitting the one or more uplink messages based on the second priority being greater than the first priority.

In some examples of the method, half-duplex UEs, and non-transitory computer-readable medium described herein, priority may be defined per message and each of the first priority and the second priority may be indicated via at least one bit.

In some examples of the method, half-duplex UEs, and non-transitory computer-readable medium described herein, the first priority may be based on a downlink channel associated with the one or more downlink messages, the second priority may be based on an uplink channel associated with the one or more uplink messages, and the UE determines which of the first priority and the second priority may be the higher priority based on a table comparing the downlink channel and the uplink channel.

In some examples of the method, half-duplex UEs, and non-transitory computer-readable medium described herein, communicating the one or more downlink messages or the one or more uplink messages may include operations, features, means, or instructions for communicating the one or more downlink messages or the one or more uplink messages based on the channel priority order.

In some examples of the method, half-duplex UEs, and non-transitory computer-readable medium described herein, communicating the one or more downlink messages or the one or more uplink messages may include operations, features, means, or instructions for receiving the one or more downlink messages based on the first channel being associated with a higher priority than the second channel in accordance with the channel priority order and transmitting the one or more uplink messages based on the second channel being associated with a higher priority than the first channel in accordance with the channel priority order.

In some examples of the method, half-duplex UEs, and non-transitory computer-readable medium described herein, the channel priority order includes synchronization signal blocks, random access occasions, physical downlink control channels, physical uplink control channels, physical downlink shared channels, physical uplink shared channels, channel state information reference signals, and sounding reference signals, as ordered from highest priority to lowest priority.

In some examples of the method, half-duplex UEs, and non-transitory computer-readable medium described herein, the channel priority order includes aperiodic physical random access channels, aperiodic physical uplink control channels, dynamic grant physical downlink shared channels, dynamic grant physical uplink shared channels, aperiodic channel state information reference signals, and aperiodic sounding reference signals, as ordered from highest priority to lowest priority.

In some examples of the method, half-duplex UEs, and non-transitory computer-readable medium described herein, communicating the one or more downlink messages or the one or more uplink messages may include operations, features, means, or instructions for communicating the one or more downlink messages or the one or more uplink messages based on the comparison between the first transmission periodicity and the second transmission periodicity.

In some examples of the method, half-duplex UEs, and non-transitory computer-readable medium described herein, a semi-persistent transmission periodicity may be associated with a higher priority than a periodic transmission periodicity.

In some examples of the method, half-duplex UEs, and non-transitory computer-readable medium described herein, communicating the one or more downlink messages or the one or more uplink messages may include operations, features, means, or instructions for communicating the one or more downlink messages or the one or more uplink messages based on the one or more conditions associated with the UE.

In some examples of the method, half-duplex UEs, and non-transitory computer-readable medium described herein, the one or more conditions may be based on prioritizing uplink coverage, prioritizing uplink latency, prioritizing monitoring occasions, prioritizing tracking reference signals, or any combination thereof.

In some examples of the method, half-duplex UEs, and non-transitory computer-readable medium described herein, the one or more downlink messages may be associated with a first channel and the one or more uplink messages may be associated with a second channel and the one or more SBFD collision rules may be based on a channel pair including the first channel and the second channel.

In some examples of the method, half-duplex UEs, and non-transitory computer-readable medium described herein, communicating the one or more downlink messages or the one or more uplink messages may include operations, features, means, or instructions for communicating the one or more downlink messages or the one or more uplink messages based on comparisons between a threshold scheduling offset and each of the first scheduling offset and the second scheduling offset.

In some examples of the method, half-duplex UEs, and non-transitory computer-readable medium described herein, communicating the one or more downlink messages or the one or more uplink messages may include operations, features, means, or instructions for receiving the one or more downlink messages based on the first scheduling offset being less than the threshold scheduling offset and the second scheduling offset being greater than the threshold scheduling offset.

Some examples of the method, half-duplex UEs, and non-transitory computer-readable medium described herein may further include operations, features, means, or instructions for communicating the one or more downlink messages or the one or more uplink messages in accordance with the one or more SBFD collision rules may be based on both the first scheduling offset and the second scheduling offset being greater than the threshold scheduling offset.

In some examples of the method, half-duplex UEs, and non-transitory computer-readable medium described herein, receiving the one or more control messages scheduling the one or more downlink messages and the one or more uplink messages may include operations, features, means, or instructions for receiving, at a first time, a first control message scheduling the one or more downlink messages and receiving, at a second time, a second control message scheduling the one or more uplink messages, where the one or more SBFD collision rules indicate for the UE to communicate the one or more downlink messages or the one or more uplink messages based on a comparison between the first time and the second time.

In some examples of the method, half-duplex UEs, and non-transitory computer-readable medium described herein, communicating the one or more downlink messages or the one or more uplink messages may include operations, features, means, or instructions for receiving the one or more downlink messages based on the first time being after the second time and transmitting the one or more uplink messages based on the first time being before the second time.

In some examples of the method, half-duplex UEs, and non-transitory computer-readable medium described herein, communicating the one or more downlink messages or the one or more uplink messages may include operations, features, means, or instructions for receiving the one or more downlink synchronization signal block reference signals via the SBFD symbol based on the one or more downlink messages including the one or more downlink synchronization signal block reference signals.

In some examples of the method, half-duplex UEs, and non-transitory computer-readable medium described herein, communicating the one or more downlink messages or the one or more uplink messages may include operations, features, means, or instructions for transmitting the one or more uplink messages via the SBFD symbol based on the one or more uplink messages being associated with one or more random access occasions.

Some examples of the method, half-duplex UEs, and non-transitory computer-readable medium described herein may further include operations, features, means, or instructions for receiving a second control message indicating the one or more SBFD collision rules, where communicating the one or more downlink messages or the one or more uplink messages may be based on receiving the second control message.

In some examples of the method, half-duplex UEs, and non-transitory computer-readable medium described herein, the one or more downlink messages may be dynamically scheduled or semi-statically configured or semi-persistently configured and the one or more uplink messages may be associated with one or more random access occasions further associated with a random access procedure and the one or more SBFD collision rules may be based on whether the random access procedure was triggered dynamically or was triggered by radio resource control signaling.

In some examples of the method, half-duplex UEs, and non-transitory computer-readable medium described herein, communicating the one or more downlink messages or the one or more uplink messages may include operations, features, means, or instructions for transmitting the one or more uplink messages via the SBFD symbol based on the random access procedure being triggered dynamically via physical downlink control channel order and based on the one or more downlink messages being semi-statically configured.

In some examples of the method, half-duplex UEs, and non-transitory computer-readable medium described herein, communicating the one or more downlink messages or the one or more uplink messages may include operations, features, means, or instructions for receiving the one or more downlink messages via the SBFD symbol based on the random access procedure being triggered by the radio resource control signaling and based on the one or more downlink messages being dynamically configured via downlink control information.

In some examples of the method, half-duplex UEs, and non-transitory computer-readable medium described herein, the UE does not expect for the random access procedure to be triggered dynamically via physical downlink control channel order and for the one or more downlink messages to be dynamically configured via downlink control information simultaneously.

In some examples of the method, half-duplex UEs, and non-transitory computer-readable medium described herein, both the one or more downlink messages and the one or more uplink messages may be semi-statically configured.

In some examples of the method, half-duplex UEs, and non-transitory computer-readable medium described herein, both the one or more downlink messages and the one or more uplink messages may be dynamically scheduled.

In some examples of the method, half-duplex UEs, and non-transitory computer-readable medium described herein, the one or more downlink messages include one or more synchronization signal block reference signals and the one or more uplink messages may be dynamically scheduled or semi-statically configured or semi-persistently configured.

In some examples of the method, half-duplex UEs, and non-transitory computer-readable medium described herein, the one or more downlink messages may be dynamically scheduled or semi-statically configured or semi-persistently configured and the one or more uplink messages may be associated with one or more random access occasions.

A method for wireless communications by a network entity is described. The method may include transmitting, to a half-duplex UE, a configuration message indicating one or more SBFD symbols for the network entity, where each SBFD symbol of the one or more SBFD symbols includes one or more uplink sub-bands and one or more downlink sub-bands, transmitting one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time, and communicating, via the SBFD symbol, the one or more downlink messages or the one or more uplink messages in accordance with one or more SBFD collision rules.

A network entity for wireless communications is described. The network entity may include one or more memories storing processor executable code, and one or more processors coupled with the one or more memories. The one or more processors may individually or collectively be operable to execute the code to cause the network entity to transmit, to a half-duplex UE, a configuration message indicating one or more SBFD symbols for the network entity, where each SBFD symbol of the one or more SBFD symbols includes one or more uplink sub-bands and one or more downlink sub-bands, transmit one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time, and communicate, via the SBFD symbol, the one or more downlink messages or the one or more uplink messages in accordance with one or more SBFD collision rules.

Another network entity for wireless communications is described. The network entity may include means for transmitting, to a half-duplex UE, a configuration message indicating one or more SBFD symbols for the network entity, where each SBFD symbol of the one or more SBFD symbols includes one or more uplink sub-bands and one or more downlink sub-bands, means for transmitting one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time, and means for communicating, via the SBFD symbol, the one or more downlink messages or the one or more uplink messages in accordance with one or more SBFD collision rules.

A non-transitory computer-readable medium storing code for wireless communications is described. The code may include instructions executable by one or more processors to transmit, to a half-duplex UE, a configuration message indicating one or more SBFD symbols for the network entity, where each SBFD symbol of the one or more SBFD symbols includes one or more uplink sub-bands and one or more downlink sub-bands, transmit one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time, and communicate, via the SBFD symbol, the one or more downlink messages or the one or more uplink messages in accordance with one or more SBFD collision rules.

In some examples of the method, network entities, and non-transitory computer-readable medium described herein, communicating the one or more downlink messages or the one or more uplink messages may include operations, features, means, or instructions for transmitting the one or more downlink messages based on the one or more SBFD collision rules indicating for the UE to prioritize the one or more downlink messages and receiving the one or more uplink messages based on the one or more SBFD collision rules indicating for the UE to prioritize the one or more uplink messages.

In some examples of the method, network entities, and non-transitory computer-readable medium described herein, both the one or more downlink messages and the one or more uplink messages may be semi-statically configured.

In some examples of the method, network entities, and non-transitory computer-readable medium described herein, the one or more downlink messages include one or more synchronization signal block reference signals and the one or more uplink messages may be dynamically scheduled or semi-statically configured or semi-persistently configured.

In some examples of the method, network entities, and non-transitory computer-readable medium described herein, the one or more downlink messages may be dynamically scheduled or semi-statically configured or semi-persistently configured and the one or more uplink messages may be associated with one or more random access occasions.

In some examples of the method, network entities, and non-transitory computer-readable medium described herein, communicating the one or more downlink messages or the one or more uplink messages may include operations, features, means, or instructions for communicating the one or more downlink messages or the one or more uplink messages based on whether the SBFD symbol may be configured on the downlink symbol or on the flexible symbol.

In some examples of the method, network entities, and non-transitory computer-readable medium described herein, communicating the one or more downlink messages or the one or more uplink messages may include operations, features, means, or instructions for transmitting the one or more downlink messages based on the SBFD symbol being configured on the downlink symbol and receiving the one or more uplink messages based on the SBFD symbol being configured on the flexible symbol.

In some examples of the method, network entities, and non-transitory computer-readable medium described herein, communicating the one or more downlink messages or the one or more uplink messages may include operations, features, means, or instructions for communicating the one or more downlink messages or the one or more uplink messages based on whether the one or more downlink messages or the one or more uplink messages includes the flag.

In some examples of the method, network entities, and non-transitory computer-readable medium described herein, communicating the one or more downlink messages or the one or more uplink messages may include operations, features, means, or instructions for transmitting the one or more downlink messages based on the one or more downlink messages including the flag and receiving the one or more uplink messages based on the one or more uplink messages including the flag.

In some examples of the method, network entities, and non-transitory computer-readable medium described herein, communicating the one or more downlink messages or the one or more uplink messages may include operations, features, means, or instructions for communicating the one or more downlink messages or the one or more uplink messages based on whether the one or more downlink messages or the one or more uplink messages may be associated with the higher priority.

In some examples of the method, network entities, and non-transitory computer-readable medium described herein, communicating the one or more downlink messages or the one or more uplink messages may include operations, features, means, or instructions for transmitting the one or more downlink messages based on the first priority being greater than the second priority and receiving the one or more uplink messages based on the second priority being greater than the first priority.

In some examples of the method, network entities, and non-transitory computer-readable medium described herein, priority may be defined per message and each of the first priority and the second priority may be indicated via at least one bit.

In some examples of the method, network entities, and non-transitory computer-readable medium described herein, the first priority may be based on a downlink channel associated with the one or more downlink messages, the second priority may be based on an uplink channel associated with the one or more uplink messages, and the network entity determines which of the first priority and the second priority may be the higher priority based on a table comparing the downlink channel and the uplink channel.

In some examples of the method, network entities, and non-transitory computer-readable medium described herein, communicating the one or more downlink messages or the one or more uplink messages may include operations, features, means, or instructions for communicating the one or more downlink messages or the one or more uplink messages based on the channel priority order.

In some examples of the method, network entities, and non-transitory computer-readable medium described herein, communicating the one or more downlink messages or the one or more uplink messages may include operations, features, means, or instructions for transmitting the one or more downlink messages based on the first channel being associated with a higher priority than the second channel in accordance with the channel priority order and receiving the one or more uplink messages based on the second channel being associated with a higher priority than the first channel in accordance with the channel priority order.

In some examples of the method, network entities, and non-transitory computer-readable medium described herein, the channel priority order includes synchronization signal blocks, random access occasions, physical downlink control channels, physical uplink control channels, physical downlink shared channels, physical uplink shared channels, channel state information reference signals, and sounding reference signals, as ordered from highest priority to lowest priority.

In some examples of the method, network entities, and non-transitory computer-readable medium described herein, the channel priority order includes aperiodic physical random access channels, aperiodic physical uplink control channels, dynamic grant physical downlink shared channels, dynamic grant physical uplink shared channels, aperiodic channel state information reference signals, and aperiodic sounding reference signals, as ordered from highest priority to lowest priority.

In some examples of the method, network entities, and non-transitory computer-readable medium described herein, communicating the one or more downlink messages or the one or more uplink messages may include operations, features, means, or instructions for communicating the one or more downlink messages or the one or more uplink messages based on the comparison between the first transmission periodicity and the second transmission periodicity.

In some examples of the method, network entities, and non-transitory computer-readable medium described herein, a semi-persistent transmission periodicity may be associated with a higher priority than a periodic transmission periodicity.

In some examples of the method, network entities, and non-transitory computer-readable medium described herein, communicating the one or more downlink messages or the one or more uplink messages may include operations, features, means, or instructions for communicating the one or more downlink messages or the one or more uplink messages based on the one or more conditions associated with the UE.

In some examples of the method, network entities, and non-transitory computer-readable medium described herein, the one or more conditions may be based on prioritizing uplink coverage, prioritizing uplink latency, prioritizing monitoring occasions, prioritizing tracking reference signals, or any combination thereof.

In some examples of the method, network entities, and non-transitory computer-readable medium described herein, the one or more downlink messages may be associated with a first channel and the one or more uplink messages may be associated with a second channel and the one or more SBFD collision rules may be based on a channel pair including the first channel and the second channel.

In some examples of the method, network entities, and non-transitory computer-readable medium described herein, communicating the one or more downlink messages or the one or more uplink messages may include operations, features, means, or instructions for communicating the one or more downlink messages or the one or more uplink messages based on comparisons between a threshold scheduling offset and each of the first scheduling offset and the second scheduling offset.

In some examples of the method, network entities, and non-transitory computer-readable medium described herein, communicating the one or more downlink messages or the one or more uplink messages may include operations, features, means, or instructions for transmitting the one or more downlink messages based on the first scheduling offset being less than the threshold scheduling offset and the second scheduling offset being greater than the threshold scheduling offset.

Some examples of the method, network entities, and non-transitory computer-readable medium described herein may further include operations, features, means, or instructions for communicating the one or more downlink messages or the one or more uplink messages in accordance with the one or more SBFD collision rules may be based on both the first scheduling offset and the second scheduling offset being greater than the threshold scheduling offset.

In some examples of the method, network entities, and non-transitory computer-readable medium described herein, transmitting the one or more control messages scheduling the one or more downlink messages and the one or more uplink messages may include operations, features, means, or instructions for transmitting, at a first time, a first control message scheduling the one or more downlink messages and transmitting, at a second time, a second control message scheduling the one or more uplink messages, where the one or more SBFD collision rules indicate for the network entity to communicate the one or more downlink messages or the one or more uplink messages based on a comparison between the first time and the second time.

In some examples of the method, network entities, and non-transitory computer-readable medium described herein, communicating the one or more downlink messages or the one or more uplink messages may include operations, features, means, or instructions for transmitting the one or more downlink messages based on the first time being after the second time and receiving the one or more uplink messages based on the first time being before the second time.

In some examples of the method, network entities, and non-transitory computer-readable medium described herein, communicating the one or more downlink messages or the one or more uplink messages may include operations, features, means, or instructions for transmitting the one or more downlink synchronization signal block reference signals via the SBFD symbol based on the one or more downlink messages including the one or more downlink synchronization signal block reference signals.

In some examples of the method, network entities, and non-transitory computer-readable medium described herein, communicating the one or more downlink messages or the one or more uplink messages may include operations, features, means, or instructions for receiving the one or more uplink messages via the SBFD symbol based on the one or more uplink messages being associated with one or more random access occasions.

Some examples of the method, network entities, and non-transitory computer-readable medium described herein may further include operations, features, means, or instructions for transmitting a second control message indicating the one or more SBFD collision rules, where communicating the one or more downlink messages or the one or more uplink messages may be based on receiving the second control message.

In some examples of the method, network entities, and non-transitory computer-readable medium described herein, the one or more downlink messages may be dynamically scheduled or semi-statically configured or semi-persistently configured and the one or more uplink messages may be associated with one or more random access occasions, the one or more uplink messages may be associated with one or more random access occasions further associated with a random access procedure, and the one or more SBFD collision rules may be based on whether the random access procedure was triggered dynamically or was triggered by radio resource control signaling.

In some examples of the method, network entities, and non-transitory computer-readable medium described herein, communicating the one or more downlink messages or the one or more uplink messages may include operations, features, means, or instructions for receiving the one or more uplink messages via the SBFD symbol based on the random access procedure being triggered dynamically via physical downlink control channel order and based on the one or more downlink messages being semi-statically configured.

In some examples of the method, network entities, and non-transitory computer-readable medium described herein, communicating the one or more downlink messages or the one or more uplink messages may include operations, features, means, or instructions for transmitting the one or more downlink messages via the SBFD symbol based on the random access procedure being triggered by the radio resource control signaling and based on the one or more downlink messages being dynamically configured via downlink control information.

In some examples of the method, network entities, and non-transitory computer-readable medium described herein, the network entity does not schedule the random access procedure to be triggered dynamically via physical downlink control channel order and the one or more downlink messages to be dynamically configured via downlink control information simultaneously.

Some examples of the method, network entities, and non-transitory computer-readable medium described herein may further include operations, features, means, or instructions for communicating the one or more downlink messages or the one or more uplink messages in accordance with the one or more SBFD collision rules may be based on the random access procedure being triggered by the radio resource control signaling and based on the one or more downlink messages being semi-statically configured.

In some examples of the method, network entities, and non-transitory computer-readable medium described herein, both the one or more downlink messages and the one or more uplink messages may be semi-statically configured.

In some examples of the method, network entities, and non-transitory computer-readable medium described herein, both the one or more downlink messages and the one or more uplink messages may be dynamically scheduled.

In some examples of the method, network entities, and non-transitory computer-readable medium described herein, the one or more downlink messages include one or more synchronization signal block reference signals and the one or more uplink messages may be dynamically scheduled or semi-statically configured or semi-persistently configured.

In some examples of the method, network entities, and non-transitory computer-readable medium described herein, the one or more downlink messages may be dynamically scheduled or semi-statically configured or semi-persistently configured and the one or more uplink messages may be associated with one or more random access occasions.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for resolving sub-band full-duplex (SBFD) time domain collisions in accordance with one or more aspects of the present disclosure.

FIG. 2 shows an example of a wireless communications system that supports techniques for resolving SBFD time domain collisions in accordance with one or more aspects of the present disclosure.

FIG. 3 shows an example of a process flow that supports techniques for resolving SBFD time domain collisions in accordance with one or more aspects of the present disclosure.

FIGS. 4 and 5 show block diagrams of devices that support techniques for resolving SBFD time domain collisions in accordance with one or more aspects of the present disclosure.

FIG. 6 shows a block diagram of a communications manager that supports techniques for resolving SBFD time domain collisions in accordance with one or more aspects of the present disclosure.

FIG. 7 shows a diagram of a system including a device that supports techniques for resolving SBFD time domain collisions in accordance with one or more aspects of the present disclosure.

FIGS. 8 and 9 show block diagrams of devices that support techniques for resolving SBFD time domain collisions in accordance with one or more aspects of the present disclosure.

FIG. 10 shows a block diagram of a communications manager that supports techniques for resolving SBFD time domain collisions in accordance with one or more aspects of the present disclosure.

FIG. 11 shows a diagram of a system including a device that supports techniques for resolving SBFD time domain collisions in accordance with one or more aspects of the present disclosure.

FIG. 12 shows a flowchart illustrating methods that support techniques for resolving SBFD time domain collisions in accordance with one or more aspects of the present disclosure.

### DETAILED DESCRIPTION

In some wireless communications systems, a network entity may operate according to a sub-band full-duplex (SBFD) mode in which the network entity may simultaneously transmit and receive communications. In such cases, the network entity may configure symbols of a user equipment (UE), which may be referred to as an SBFD-aware UE, in accordance with an SBFD pattern. That is, the network entity may configure the SBFD-aware UE with one or more SBFD symbols, where each SBFD symbol includes one or more uplink sub-bands (e.g., for uplink transmissions) and one or more downlink sub-bands (e.g., for downlink transmissions). As such, the network entity may transmit one or more downlink messages via the one or more downlink sub-bands of an SBFD symbol and may receive one or more uplink messages via the one or more uplink sub-bands of the SBFD symbol. However, in some cases, the one or more downlink messages may at least partially overlap with the one or more uplink messages in a time domain causing a collision, which may be referred to as an SBFD time-domain collision or simply an SBFD collision. In other words, the SBFD-aware UE may receive one or more control messages scheduling the one or more uplink messages via the SBFD symbol and the one or more downlink messages via the SBFD symbol, where the one or more downlink messages may at least partially overlap with the one or more uplink messages in the time domain. In such cases, the SBFD-aware UE may be unable to determine whether to transmit the one or more uplink messages, receive the one or more downlink messages, or neither.

Accordingly, techniques described herein may enable an SBFD-aware UE to determine, when an SBFD collision occurs, whether to communicate one or more uplink messages, one or more downlink messages, or neither, during an SBFD symbol according to one or more SBFD collision rules. For example, in some cases, the one or more SBFD collision rules may indicate for the SBFD UE to drop both the one or more uplink messages and the one or more downlink messages based on the SBFD collision (e.g., SBFD collision results in an error case or an invalid case). In some other cases, the one or more SBFD collision rules may indicate for the SBFD UE to transmit (e.g., always transmit) the one or more uplink messages or, conversely, to receive (e.g., always receive) the one or more downlink messages.

In some other cases, the one or more SBFD collision rules may define one or more conditions for the SBFD-aware UE to use to determine whether to transmit the one or more uplink messages or receive the one or more downlink messages. For example, the one or more SBFD collision rules may indicate for the SBFD-aware UE to transmit the one or more uplink messages based on the SBFD symbol being configured on a flexible symbol or to receive the one or more downlink messages based on the SBFD symbol being configured on a downlink symbol. In another example, the one or more SBFD collision rules may indicate for the SBFD-aware UE to transmit the one or more uplink messages or receive the one or more downlink messages based on whether the one or more downlink messages or the one or more uplink messages comprise a flag (e.g., indicating prioritization). In another example, the one or more SBFD collision rules may indicate for the SBFD-aware UE to transmit the one or more uplink messages or receive the one or more downlink messages based on a comparison of respective priorities, a comparison of respective channel types (e.g., according to a channel priority order), a comparison of respective transmission periodicities, comparisons of respective scheduling offsets relative to a scheduling offset threshold, or any combination thereof.

Additionally, or alternatively, the one or more SBFD collision rules may indicate for the SBFD-aware UE to transmit the one or more uplink messages or receive the one or more downlink messages based on one or more conditions at the UE (e.g., up to UE implementation), based on signaling from the network entity (e.g., signaling indicating the one or more rules), or both.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to techniques for resolving SBFD time domain collisions.

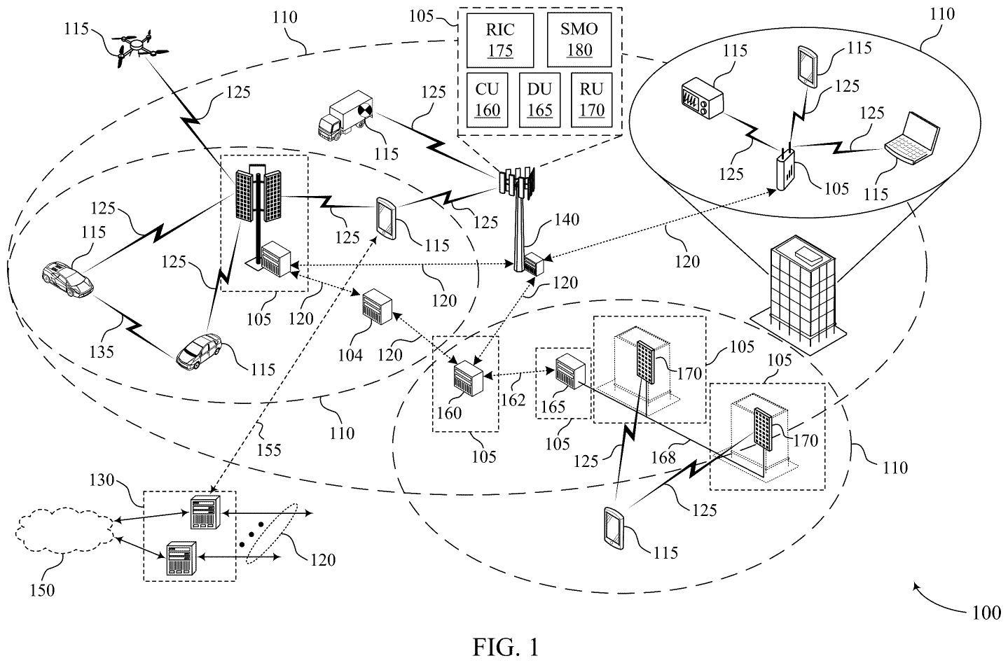

FIG. 1 shows an example of a wireless communications system 100 that supports techniques for resolving SBFD time domain collisions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may support techniques for resolving SBFD time domain collisions at an SBFD-aware UE 115. That is, the SBFD-aware UE 115 may determine, when an SBFD collision occurs, whether to communicate one or more uplink messages, one or more downlink messages, or neither, during an SBFD symbol according to one or more SBFD collision rules. For example, in some cases, the one or more SBFD collision rules may indicate for the SBFD UE 115 to drop both the one or more uplink messages and the one or more downlink messages based on the SBFD collision (e.g., SBFD collision results in an error case). In some other cases, the one or more SBFD collision rules may indicate for the SBFD UE 115 to transmit (e.g., always transmit) the one or more uplink messages or, conversely, to receive (e.g., always receive) the one or more downlink messages.

In some other cases, the one or more SBFD collision rules may define one or more conditions for the SBFD-aware UE 115 to use to determine whether to transmit the one or more uplink messages or receive the one or more downlink messages. For example, the one or more SBFD collision rules may indicate for the SBFD-aware UE 115 to transmit the one or more uplink messages based on the SBFD symbol being configured on a flexible symbol or to receive the one or more downlink messages based on the SBFD symbol being configured on a downlink symbol. In another example, the one or more SBFD collision rules may indicate for the SBFD-aware UE 115 to transmit the one or more uplink messages or receive the one or more downlink messages based on whether the one or more downlink messages or the one or more uplink messages comprise a flag (e.g., indicating prioritization). In another example, the one or more SBFD collision rules may indicate for the SBFD-aware UE 115 to transmit the one or more uplink messages or receive the one or more downlink messages based on a comparison of respective priorities, a comparison of respective channel types (e.g., according to a channel priority order), a comparison of respective transmission periodicities, comparisons of respective scheduling offsets relative to a scheduling offset threshold, or any combination thereof.

Additionally, or alternatively, the one or more SBFD collision rules may indicate for the SBFD-aware UE 115 to transmit the one or more uplink messages or receive the one or more downlink messages based on one or more conditions at the UE 115 (e.g., up to UE 115 implementation), based on signaling from a network entity 105 (e.g., signaling indicating the one or more rules), or both.

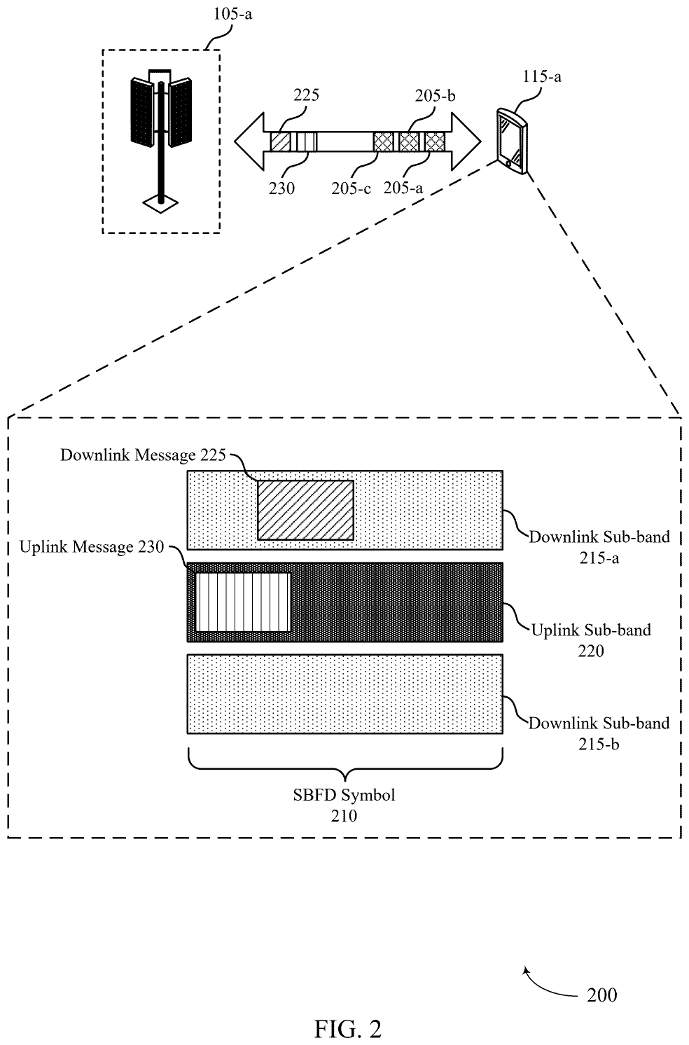

FIG. 2 shows an example of a wireless communications system 200 that supports techniques for resolving SBFD time domain collisions in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, a network entity 105-a may operate according to an SBFD mode in which the network entity 105-a may simultaneously transmit downlink communications (e.g., one or more downlink messages 225) and receive uplink communications (e.g., one or more uplink messages 230). In such cases, the network entity 105-a may configure symbols (e.g., downlink symbols, flexible symbols) of a UE 115-a in accordance with an SBFD pattern. That is, the network entity 105-a may transmit, to the UE 115-a, a control message 205-a indicating configuration information associated with the SBFD pattern, where the configuration information indicates one or more SBFD symbols 210 and, for each SBFD symbol 210 of the one or more SBFD symbols 210, one or more uplink sub-bands 220 of the SBFD symbol (e.g., for uplink transmissions) and one or more downlink sub-bands 215 of the SBFD symbol (e.g., for downlink transmissions). For example, the control message 205-a may indicate an SBFD symbol 210 with a downlink sub-band 215-a and a downlink sub-band 215-b separated by an uplink sub-band 220 (e.g., and by one or more guard bands).

In some cases, the UE 115-a may be a half-duplex UE 115-a (e.g., SBFD-aware UE 115-a), such that the UE 115-a may not be capable of simultaneously receiving downlink communications and transmitting uplink communications in an SBFD symbol 210. Thus, in some cases, the network entity 105-a may transmit one or more control message 205 scheduling one or more downlink messages 225 via an SBFD symbol 210 and one or more uplink message 230 via the SBFD symbol 210, where the one or more downlink messages 225 at least partially overlap with the one or more uplink messages 230 in a time domain, such that a collision occurs between the one or more downlink messages 225 and the one or more uplink messages 230. In other words, the UE 115-a may not be able to receive the one or more downlink message 225 and transmit the one or more uplink messages 225 in the SBFD symbol based on the UE 115-a being a half-duplex UE 115-a (e.g., SBFD-aware UE 115-a). In such cases, the collision may be referred to as an SBFD collision or an SBFD time domain collision. For example, as depicted in FIG. 2, the UE 115-a may receive a control message 205-b scheduling a downlink message 225 (e.g., downlink reception) via the downlink sub-band 215-a of the SBFD symbol 210 and may receive a control message 205-c scheduling an uplink message 230 (e.g., uplink transmission) via the uplink sub-band 220 of the SBFD symbol 210, where the downlink message 225 at least partially overlaps with the uplink message 230.

In some cases, the network entity 105-a, the UE 115-a, or both, may avoid (e.g., address or alleviate) an SBFD collision based on scheduling. However, in some other cases (e.g., if the network entity 105-a does not indicate link direction for an SBFD symbol 210), the network entity 105-a, the UE 115-a, or both, may not be able avoid (e.g., address or alleviate) an SBFD collision based on scheduling. For example, dynamically scheduled downlink communications (e.g., dynamic physical downlink shared channel (PDSCH) or channel state information-reference signal (CSI-RS)) may collide with semi-statically configured uplink communications (e.g., sounding reference signal (SRS), physical uplink control channel (PUCCH), or configured grant (CG)-physical uplink shared channel (PUSCH)). Additionally, or alternatively, semi-statically configured downlink communications (e.g., PDSCH or semi-persistent scheduling (SPS) PDSCH) may collide with dynamically scheduled uplink communications (e.g., dynamic PUSCH or PUCCH). Additionally, or alternatively, semi-statically configured downlink communications may collide with semi-statically configured uplink communications. Additionally, or alternatively, dynamically scheduled downlink communications may collide with dynamically scheduled uplink communications. Additionally, or alternatively, synchronization signal block (SSB) transmissions may collied with dynamically scheduled or configured uplink communications (e.g., PUSCH, PUCCH, physical random access channel (PRACH), SRS). Additionally, or alternatively, dynamically scheduled or semi-statically configured downlink communications may collide with a valid random access occasion (RO).

Accordingly, techniques described herein may enable the UE 115-a to determine whether to transmit one or more uplink messages 230 or receive one or more downlink messages 225 when an SBFD time domain collision occurs between the one or more uplink messages 230 and the one or more downlink messages 225. For example, as described previously, the UE 115-a may receive a control message 205-a indicating an SBFD symbol 210 with a downlink sub-band 215-a and a downlink sub-band 215-b separated by an uplink sub-band 220 (e.g., and by one or more guard bands). Additionally, the UE 115-a may receive a control message 205-b scheduling a downlink message 225 (e.g., downlink reception) via the downlink sub-band 215-a of the SBFD symbol 210 and may receive a control message 205-c scheduling an uplink message 230 via the uplink sub-band 220 of the SBFD symbol 210, where the downlink message 225 at least partially overlaps with the uplink message 230.

In some examples, the downlink message 225 may be semi-statically configured (e.g., may be a semi-statically configured downlink message 225) and the uplink message 230 may be also be semi-statically configured (e.g., may be a semi-statically configured uplink message 230). In some cases, regardless of whether the SBFD symbol 210 was configured on a downlink (e.g., D) symbol or a flexible (e.g., F) symbol, the UE 115-a may either prioritize the semi-statically configured downlink message 225 or may prioritize the semi-statically configured uplink message 230 (e.g., according to a first SBFD collision rule). That is, based on an SBFD collision, the UE 115-a may either receive (e.g., always receive) semi-statically configured downlink messages 225 or may transmit (e.g., always transmit) semi-statically configured uplink messages 230.

Additionally, or alternatively, the UE 115-a may determine whether to transmit the semi-statically configured uplink message 230 or receive the semi-statically configured downlink message 225 based on whether the SBFD symbol 210 was configured on a downlink symbol or a flexible symbol (e.g., according to a second SBFD collision rule). For example, the UE 115-a may receive (e.g., to prioritize) the semi-statically configured downlink message 225 based on the SBFD symbol 210 being configured on a downlink symbol or may transmit (e.g., to prioritize) the semi-statically configured uplink message 230 based on the SBFD symbol 210 being configured on a flexible symbol.

Additionally, or alternatively, the UE 115-a may determine whether to transmit the semi-statically configured uplink message 230 or receive the semi-statically configured downlink message 225 based on whether the semi-statically configured downlink message 225 or the semi-statically configured uplink message 230 includes a flag (e.g., according to a third SBFD collision rule). For example, the UE 115-a may receive (e.g., to prioritize) the semi-statically configured downlink message 225 based on the semi-statically configured downlink message 225 including the flag or may transmit (e.g., to prioritize) the semi-statically configured uplink message 230 based on the semi-statically configured uplink message 230 including the flag.

Additionally, or alternatively, the UE 115-a may determine whether to transmit the semi-statically configured uplink message 230 or receive the semi-statically configured downlink message 225 based on a comparison of a respective priority associated with each message (e.g., according to a fourth SBFD collision rule). For example, in some cases, the semi-statically configured downlink message 225 may be associated with a first priority and the semi-statically configured uplink message 230 may be associated with a second priority, where the first priority and the second priority are message type agnostic (e.g., do not depend on whether a message is a downlink message 225 or an uplink message 225). That is, the first priority and the second priority may be relative to each other (e.g., directly comparable). For example, each of the first priority and the second priority may be associated with 3 bits, where a value of ‘000’ indicates a lowest priority level and a value of ‘111’ indicates a highest priority level, such that the rule may indicate for the UE 115-a to determine whether to transmit the semi-statically configured uplink message 230 or receive the semi-statically configured downlink message 225 based on a comparison (e.g., direct comparison) between the first priority and the second priority. In some other cases, the semi-statically configured downlink message 225 may be associated with a first priority and the semi-statically configured uplink message 230 may be associated with a second priority, where the first priority and the second priority are message type specific (e.g., depend on whether a message is a downlink message 225 or an uplink message 225). That is, the first priority may be based on a downlink channel associated with the one or more downlink messages 225 relative to downlink channels supported by the UE 115-a (e.g., may be per downlink message 225) and the second priority may be based on an uplink channel associated with the one or more uplink messages 230 relative to uplink channels supported by the UE 115-a (e.g., may be per uplink message 230). Additionally, the UE 115-a may be configured with (e.g., may support) a table indicating each downlink channel (e.g., downlink reference signa) supported by the UE 115-a and each uplink channel (e.g., uplink reference signal) supported by the UE 115-a and correspondingly which downlink channel or uplink channel to prioritize in each channel pairing (e.g., each pair of a downlink channel and an uplink channel).

Additionally, or alternatively, the UE 115-a may determine whether to transmit the semi-statically configured uplink message 230 or receive the semi-statically configured downlink message 225 based on a comparison of a respective channel associated with each message (e.g., the semi-statically configured uplink message 230, the semi-statically configured downlink message 225) in accordance with a channel priority order (e.g., according to a fifth SBFD collision rule). For example, the network entity 105-a may transmit a control message 205 indicating a channel priority order based on different uplink channels and downlink channels (e.g., relative to each other). As such, the UE 115-a may determine whether to transmit the semi-statically configured uplink message 230 or receive the semi-statically configured downlink message 225 based on whether a downlink channel associated with the semi-statically configured downlink message 225 or an uplink channel associated with the semi-statically configured uplink message 230 is higher in the channel priority order. For example, the UE 115-a may transmit the semi-statically configured uplink message 230 based on the uplink channel being associated with a higher priority than the downlink channel in accordance with the channel priority order. Alternatively, the UE 115-a may receive receive the semi-statically configured downlink message 225 based on the downlink channel being associated with a higher priority than the uplink channel in accordance with the channel priority order. In some cases, the channel priority order may include the following channels and reference signal types ordered from highest priority to lowest priority (e.g., decreasing priority order): SSB, RO, PDCCH, PUCCH, PDSCH, PUSCH, CSI-RS, and SRS.

Additionally, or alternatively, the UE 115-a may drop both the semi-statically configured uplink message 230 and the semi-statically configured downlink message 225 based on the SBFD collision (e.g., according to a sixth SBFD collision rule). In other words, the UE 115-a may not expect (e.g., may not support) to multiplex the semi-statically configured downlink message 225 and the semi-statically configured uplink message 230, such that the UE 115-a drops both the semi-statically configured uplink message 230 and the semi-statically configured downlink message 225 based on the SBFD collision.

Additionally, or alternatively, the UE 115-a may determine whether to transmit the semi-statically configured uplink message 230 or receive the semi-statically configured downlink message 225 based on a comparison of a respective transmission periodicity (e.g., time domain behavior) associated with each message (e.g., according to a seventh SBFD collision rule). For example, the UE 115-a may prioritize a first message (e.g., a first downlink message 225 or a second uplink message 230) associated with a semi-persistent (SP) transmission periodicity over a second message (e.g., an uplink message 230 or a second downlink message 225, respectively) associated with a periodic (P) transmission periodicity. As an illustrative example, a semi-persistent SRS may be prioritized (e.g., associated with a higher priority) over a periodic CSI-RS.

Additionally, or alternatively, the UE 115-a may determine whether to transmit the semi-statically configured uplink message 230 or receive the semi-statically configured downlink message 225 based on one or more conditions at the UE 115-a (e.g., according to an eight SBFD collision rule). In other words, determining whether to transmit the semi-statically configured uplink message 230 or receive the semi-statically configured downlink message 225 may be based on UE-implementation. For example, the UE 115-a may prioritize the uplink message 230 over the downlink message 225 for coverage enhancements, latency enhancements, or both, unless the downlink message 225 is associated with a PDCCH monitoring occasion (MO) or a tracking reference signal (TRS) (e.g., at which time the UE 115-a may prioritize the downlink message 225).

Additionally, or alternatively, the UE 115-a may determine whether to transmit the semi-statically configured uplink message 230 or receive the semi-statically configured downlink message 225 based on a channel pair between a downlink channel associated with the semi-statically configured downlink message 225 and an uplink channel associated with the semi-statically configured uplink message 230 (E.g., according to a ninth SBFD collision rule). For example, the UE 115-a may identify the channel pair between the downlink channel and the uplink channel in Table 1 (e.g., configured at the UE 115-a) below, and determine whether to transmit the semi-statically configured uplink message 230 or receive the semi-statically configured downlink message 225 based on Table 1.

TABLE 1
Channel Pair Collision Resolution Rules

| | | Semi-Statically Configured | | | |
|---|---|---|---|---|---|
| | | Downlink Message 225 | | | |
| | | PDCCH | PDSCH | CSI-RS | TRS |
| Semi- | SRS, | Prioritize | Prioritize | SP > P, | Prioritize |
| Statically | PUCCH, | PDCCH | Uplink | Prioritize | TRS |
| Configured | PUSCH | | | Uplink | |
| Uplink | Valid RO | Prioritize | Prioritize | Prioritize | Prioritize |
| Message | (PRACH) | PRACH | PRACH | PRACH | PRACH |
| 230 | | | | | |

In some other examples, the downlink message 225 may be dynamically scheduled (e.g., may be a dynamically scheduled downlink message 225) and the uplink message 230 may be also be dynamically scheduled (e.g., may be a dynamically scheduled uplink message 230). In some cases, an SBFD collision between the dynamically scheduled downlink message 225 and the dynamically scheduled uplink message 230 may result in an error case (e.g., according to a tenth SBFD collision rule). In such cases, the UE 115-a may drop both the dynamically scheduled downlink message 225 and the dynamically scheduled uplink message 230.

Additionally, or alternatively, the UE 115-a may determine whether to transmit the dynamically scheduled uplink message 230 or receive the dynamically scheduled downlink message 225 based on comparisons between respective scheduling offsets and a threshold scheduling offset. In some cases, the UE 115-a may determine to receive the dynamically scheduled downlink message 225 based on a downlink scheduling offset (e.g., downlink control information (DCI) to DG PDSCH) associated with the dynamically scheduled downlink message 225 being less than the threshold scheduling offset (e.g., minimum scheduling offset) and an uplink scheduling offset (e.g., DCI to DG PUSCH) associated with the dynamically scheduled uplink message 230 being greater than the threshold scheduling offset (e.g., according to an eleventh SBFD collision rule). In some other cases, both the downlink scheduling offset and the uplink scheduling offset may be greater than the threshold scheduling offset. In such cases, the UE 115-a may prioritize the dynamically scheduled uplink message 230 (e.g., according to a twelfth SBFD collision rule). Additionally, or alternatively, the UE 115-a may apply any of the first SBFD collision rule through the ninth SBFD collision rule based on both the downlink scheduling offset and the uplink scheduling offset being greater than the threshold scheduling offset. However (e.g., for dynamically scheduled messages), the channel priority order may include the following channels and reference signal types ordered from highest priority to lowest priority (e.g., decreasing priority order): aperiodic (AP), PRACH, AP PUCCH, DG PDSCH, DG PUSCH, AP CSI-RS, and AP SRS.

Additionally, or alternatively, the UE 115-a may determine whether to transmit the dynamically scheduled uplink message 230 or receive the dynamically scheduled downlink message 225 based on whether the dynamically scheduled uplink message 230 or the dynamically scheduled downlink message 225 was scheduled later (e.g., according to a thirteen SBFD collision rule). For example, the UE 115-a may receive, at a first time, the control message 205-b scheduling the dynamically scheduled downlink message 225 and may receive, at a second time, the control message 205-c scheduling the dynamically scheduled uplink message 230. In such cases, the UE 115-a may transmit the dynamically scheduled uplink message 230 based on the second time being after (e.g., later than) the first time or may receive the dynamically scheduled downlink message 225 based on the first time being after the second time.

Additionally, or alternatively, the UE 115-a may determine whether to transmit the dynamically scheduled uplink message 230 or receive the dynamically scheduled downlink message 225 based on a comparison between respective physical layer (PHY) priority levels (e.g., according to a fourteenth SBFD collision rule). For example, the dynamically scheduled downlink message 225 may be associated with a first PHY priority and the dynamically scheduled uplink message 230 may be associated with a second PHY priority. In such cases, the UE 115-a may transmit the dynamically scheduled uplink message 230 based on the second PHY priority being greater than the first PHY priority or may receive the dynamically scheduled downlink message 225 based on the first PHY priority being greater than the second PHY priority.

In some other examples, the downlink message 225 may be an SSB and the uplink message 230 may be dynamically scheduled or semi-statically configured or semi-persistently configured. In some cases, an SBFD collision between the SSB and the uplink message 230 (e.g., PUSCH, PUCCH, PRACH, SRS) may result in an error case (e.g., according to a fifteenth SBFD collision rule). In such cases, the UE 115-a may drop both the SSB and the uplink message 230.

Additionally, or alternatively, the UE 115-a may either prioritize the SSB (e.g., according to a sixteenth SBFD collision rule) or may prioritize the uplink message 230 (e.g., according to a seventeenth SBFD collision rule). That is, based on an SBFD collision, the UE 115-a may either receive (e.g., always receive) SSBs or may transmit (e.g., always transmit) uplink messages 230. Additionally, or alternatively, the UE 115-a may determine whether to transmit the uplink message 230 or receive the SSB based on one or more conditions at the UE 115-a (e.g., according to an eighteenth SBFD collision rule). Additionally, or alternatively, the UE 115-a may determine whether to transmit the uplink message 230 or receive the SSB based on one or more additional controls messages 205 received from the network entity 105-a (e.g., according to a nineteenth SBFD collision rule). In other words, the one or more additional control messages 205 may indicate whether to prioritize the uplink message 230 or prioritize the SSB (e.g., based on configuration by the network entity 105-a).

In some other examples, the downlink message 225 may be dynamically scheduled or semi-statically configured or semi-persistently configured and the uplink message 230 may be associated with a valid RO. In some cases, an SBFD collision between the downlink message 225 and the valid RO may result in an error case (e.g., according to a twentieth SBFD collision rule). In such cases, the UE 115-a may drop both the downlink message 225 and the uplink message 230 associated with the valid RO.

Additionally, or alternatively, the UE 115-a may either prioritize the uplink message 230 associated with the valid RO (e.g., according to a twenty-first SBFD collision rule) or may prioritize the downlink message 225 (e.g., according to a twenty-second SBFD collision rule). That is, based on an SBFD collision, the UE 115-a may either transmit (e.g., always transmit) uplink messages 230, associated with valid ROs or may receive (e.g., always receive) downlink messages 225. Additionally, or alternatively, the UE 115-a may determine whether to transmit the uplink message 230 associated with the valid RO or receive the downlink message 225 based on one or more conditions at the UE 115-a (e.g., according to a twenty-third SBFD collision rule).

Additionally, or alternatively, the UE 115-a may determine whether to transmit the uplink message 230 associated with the valid RO or receive the downlink message 225 based on how a RACH associated with the valid RO was triggered (e.g., according to a twenty-fourth SBFD collision rule). For example, the RACH associated with the valid RO may be triggered dynamically (e.g., by PDCCH-order via DCI) or by higher layers (e.g., by RRC signaling). In such cases, the UE 115-a may determine whether to transmit the uplink message 230 associated with the valid RO or receive the downlink message 225 based on Table 2 (e.g., configured at the UE 115-a) below.

TABLE 2
PRACH Collision Resolution Rules

| | | Downlink Message 225 | |
|---|---|---|---|
| | | Semi-Statically (or Semi- | Dynamically |
| | | Persistently) Configured | Scheduled |
| Valid | PDCCH- | Prioritize PRACH | Error Case |
| RO | order | | |
| | PRACH | | |
| | RRC | Periodize PRACH | Prioritize Downlink and |
| | PRACH | | cancel Uplink (within |
| | | | cancellation timeline) |

In other words, Table 2 may define that PDCCH-order-triggered PRACH may be associated with a higher priority than a semi-statically (e.g., or semi-persistently) configured downlink message 225, that RRC-triggered PRACH may be associated with a lower priority than a dynamically scheduled (e.g., via DCI) downlink message 225, that the UE 115-a does not expect an SBFD collision between PDCCH-order-triggered PRACH and a dynamically scheduled downlink messages 225, and that the UE 115-a may apply any of the first SBFD collision rule through the ninth SBFD collision rule based on an SBFD collision between RRC-triggered PRACH and a semi-statically (e.g., or semi-persistently) configured downlink message 225.

Though depicted in the context of a single downlink message 225 and a single uplink message 230, this is not to be regarded as a limitation of the present disclosure. In this regard, one or more collisions may occur in an SBFD symbol 210 between any quantity of downlink messages 225 and any quantity of uplink messages 230.

Additionally, though described in the context of collisions between uplink communications (e.g., one or more uplink messages 230) and downlink communications (e.g., one or more downlink messages 225) in SBFD symbols 210, this is not to be regarded as a limitation of the present disclosure. In this regard, the techniques described herein may also resolve collisions between uplink communications (e.g., transmissions) and downlink communications (e.g., receptions) in different symbols (e.g., SBFD symbols 210, downlink symbols, uplink symbols, flexible symbols, or any combination thereof), where the uplink communications and the downlink communications are scheduled, at the UE 115-a, within a threshold duration (e.g., minimum transition time) of each other. In other words, the UE 115-a may employ the techniques described herein to resolve collisions between uplink communications and downlink communications (e.g., in different symbols, in a same symbol) when the UE 115-a does not have enough time to transition between the uplink communications and the downlink communications (e.g., or visa-versa).

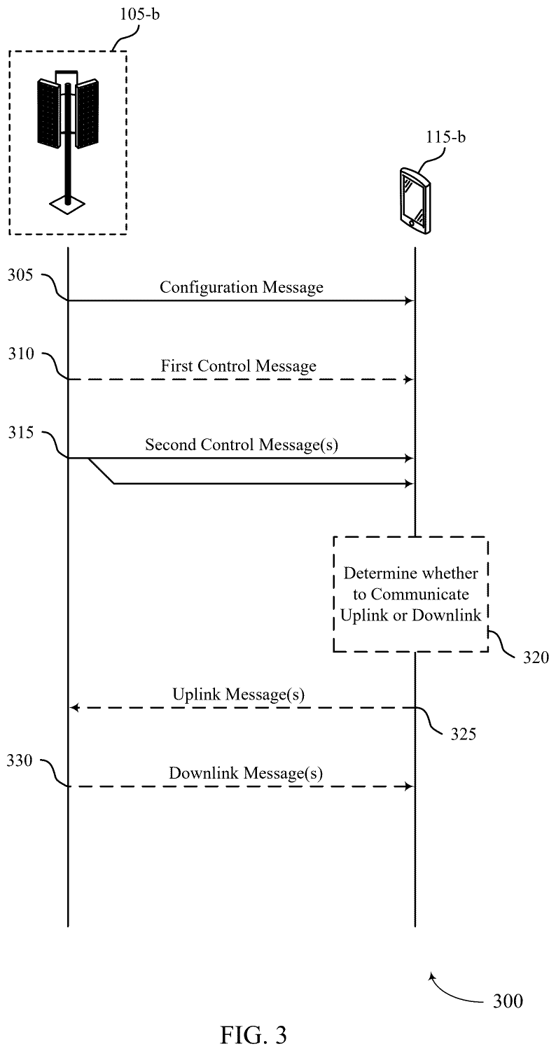

FIG. 3 shows an example of a process flow 300 that supports techniques for resolving SBFD time domain collisions in accordance with one or more aspects of the present disclosure. In some cases, the process flow 300 may implement or be implemented by aspects of the wireless communications system 100, the wireless communications system 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

At 305, the UE 115-b (e.g., a half-duplex UE 115-a, an SBFD-aware UE 115-a) may receive, from the network entity 105-b, a first configuration message (e.g., a control message) indicating one or more SBFD symbols for a network entity, where each SBFD symbol of the one or more SBFD symbols includes one or more uplink sub-bands and one or more downlink sub-bands.

In some cases, at 310, the UE 115-b may receive, from the network entity 105-b, a second configuration message (e.g., control message) indicating one or more SBFD collision rules.

At 315, the UE 115-b may receive, from the network entity 105-b, one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time (e.g., in a time domain), resulting in an SBFD collision. For example, the UE 115-a may receive, at a first time, a first control message scheduling the one or more downlink messages and receive, at a second time, a second control message scheduling the one or more uplink messages.

In some cases, both the one or more downlink messages and the one or more uplink messages may be semi-statically configured. In some other cases, both the one or more downlink messages and the one or more uplink messages may be dynamically scheduled. In some other cases, the one or more downlink messages may include one or more SSBs and the one or more uplink messages may be dynamically scheduled or semi-statically configured or semi-persistently configured. In some other cases, the one or more downlink messages may be dynamically scheduled or semi-statically configured or semi-persistently configured and the one or more uplink messages may be associated with one or more ROs.

At 320, the UE 115-b may determine whether communicate (e.g., transmit, receive) the one or more uplink messages or the one or more downlink messages in accordance with the one or more SBFD collision rules. In some cases, the UE 115-b may determine to drop both the one or more uplink messages and the one or more downlink messages based on the one or more SBFD collision rules (e.g., based on an error case, based on an invalid case).

In some cases, the one or more SBFD collision rules may indicate for the UE 115-b to transmit the one or more uplink messages based on whether the SBFD symbol is configured on a downlink symbol or on a flexible symbol.

Additionally, or alternatively, the one or more SBFD collision rules may indicate for the UE 115-b to communicate the one or more downlink messages or the one or more uplink messages based on whether the one or more downlink messages or the one or more uplink messages comprises a flag.

Additionally, or alternatively, the one or more SBFD collision rules may indicate for the UE 115-b to communicate the one or more downlink messages or the one or more uplink messages based on whether the one or more downlink messages or the one or more uplink messages are associated with a higher priority.

Additionally, or alternatively, the one or more SBFD collision rules may indicate for the UE 115-b to communicate the one or more downlink messages or the one or more uplink messages based on a channel priority order. In some cases, the channel priority order may include SSBs, ROs, PDCCHs, PUCCHs, PDSCHs, PUSCHs, CSI-RS, and SRS, as ordered from highest priority to lowest priority. In some other cases, the channel priority order may include AP PRACH, AP PUCCH, DG-PDSCH, DG-PUSCH, AP CSI-RS, and AP SRS, as ordered from highest priority to lowest priority.

Additionally, or alternatively, the one or more SBFD collision rules may indicate for the UE 115-b to communicate the one or more downlink messages or the one or more uplink messages based on a comparison between a first transmission periodicity associated with the one or more downlink messages and a second transmission periodicity associated with the one or more uplink messages. In such cases, an SP transmission periodicity may be associated with a higher priority than a P transmission periodicity.

Additionally, or alternatively, the one or more SBFD collision rules may indicate for the UE 115-b to communicate the one or more downlink messages or the one or more uplink messages based on one or more conditions associated with the UE 115-b. For example, the one or more conditions may be based on prioritizing uplink coverage, prioritizing uplink latency, prioritizing MOs, prioritizing TRS, or any combination thereof.

Additionally, or alternatively, the one or more downlink messages may be associated with a first channel and the one or more uplink messages may be associated with a second channel, such that the one or more SBFD collision rules may be based on a channel pair including the first channel and the second channel.

Additionally, or alternatively, the one or more downlink messages may be associated with a first scheduling offset and the one or more uplink messages may be associated with a second scheduling offset, such that the one or more SBFD collision rules may indicate for the UE 115-b to communicate the one or more downlink messages or the one or more uplink messages based on comparisons between a threshold scheduling offset and each of the first scheduling offset and the second scheduling offset. For example, in some cases, communicating the one or more downlink messages or the one or more uplink messages in accordance with the one or more SBFD collision rules may be based on both the first scheduling offset and the second scheduling offset being greater than the threshold scheduling offset.

Additionally, or alternatively, the one or more SBFD collision rules may indicate for the UE 115-a to communicate the one or more downlink messages or the one or more uplink messages based on a comparison between the first time and the second time.

Additionally, or alternatively, the one or more SBFD collision rules may indicate for the UE 115-b to receive the one or more downlink messages based on the one or more downlink messages including the one or more SSBs. In some other cases, the one or more SBFD collision rules may indicate for the UE 115-b to transmit the one or more uplink messages via the SBFD symbol based on the one or more uplink messages being associated with the one or more ROs.

Additionally, or alternatively, the one or more SBFD collision rules may be based on whether a random access procedure associated with the one or more ROs was triggered dynamically (e.g., via PDCCH-order) or via RRC signaling (e.g., higher layers). In some cases, the UE 115-b may not expect for the random access procedure to be triggered dynamically via PDCCH-order and for the one or more downlink messages to be dynamically configured via downlink control information simultaneously. In some other cases, the UE 115-b may determine whether to communicate the one or more uplink messages or the one or more downlink messages in accordance with the one or more SBFD collision rules based on the random access procedure being triggered by the RRC signaling and based on the one or more downlink messages being semi-statically configured.

In some cases, at 325, the UE 115-b may transmit the one or more uplink messages. For example, the UE 115-b may transmit the one or more uplink messages based on the one or more SBFD collision rules indicating for the UE 115-b to prioritize the one or more uplink messages. In another example, the UE 115-b may transmit the one or more uplink messages based on the SBFD symbol being configured on the flexible symbol. In another example, the UE 115-b may transmit the one or more uplink messages based on the one or more uplink messages including the flag.

In some other examples, the UE 115-b may transmit the one or more uplink messages based on a first priority associated with the one or more downlink messages being less than a second priority associated with the one or more uplink messages. In some cases, priority may be defined per message (e.g., per uplink message and per downlink message), such that each of the first priority and the second priority may be indicated via at least one bit (e.g., 3 bits). In some other cases, the first priority may be based on a downlink channel associated with the one or more downlink messages and the second priority may be based on an uplink channel associated with the one or more uplink messages, such that the UE 115-a may determine the first priority is less than the second priority based on a table comparing the downlink channel and the uplink channel.

In some other examples, the UE 115-b may transmit the one or more uplink messages based on the second channel being associated with a higher priority than the first channel in accordance with the channel priority order.

In some other examples, the UE 115-b may transmit the one or more uplink messages based on the first time being before the second time. In some other examples, the UE 115-b may receive the one or more SSBs via the SBFD symbol based on the one or more downlink messages including the one or more SSBs.

In some cases, the UE 115-b may transmit the one or more uplink messages based on the random access procedure being triggered dynamically via PDCCH-order and based on the one or more downlink messages being semi-statically configured.

In some other cases, at 330, the UE 115-b may receive the one or more downlink messages. For example, the UE 115-b may receive the one or more downlink messages based on the one or more SBFD collision rules indicating for the UE 115-b. to prioritize the one or more downlink messages. In another example, the UE 115-b may receive the one or more downlink messages based on the SBFD symbol being configured on the downlink symbol. In another example, the UE 115-b may receive the one or more downlink messages based on the one or more downlink messages comprising the flag.

In some other examples, the UE 115-b may receive the one or more downlink messages based on the first priority being greater than the second priority. In such cases, the UE 115-a may determine the first priority is greater than the second priority based on the table comparing the downlink channel and the uplink channel.

In some other examples, the UE 115-b may receive the one or more downlink messages based on the first channel being associated with a higher priority than the second channel in accordance with the channel priority order.

In some other examples, the UE 115-b may receive the one or more downlink messages based on the first scheduling offset being less than the threshold scheduling offset and the second scheduling offset being greater than the threshold scheduling offset.

In some other examples, the UE 115-b may receive the one or more downlink messages based on the first time being after the second time. In some other examples, the UE 115-b may transmit the one or more uplink messages via the SBFD symbol based on the one or more uplink messages being associated with the one or more ROs.

In some other examples, the UE 115-b may receive the one or more downlink messages based on the random access procedure being triggered by the RRC signaling and based on the one or more downlink messages being dynamically configured via DCI.

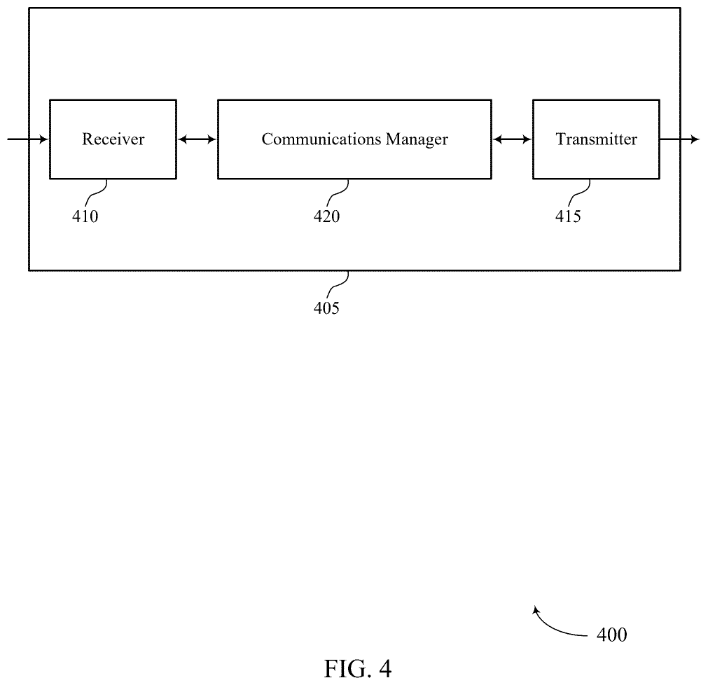

FIG. 4 shows a block diagram 400 of a device 405 that supports techniques for resolving SBFD time domain collisions in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for resolving SBFD time domain collisions). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for resolving SBFD time domain collisions). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for resolving SBFD time domain collisions as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The communications manager 420 is capable of, configured to, or operable to support a means for receiving one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The communications manager 420 is capable of, configured to, or operable to support a means for communicating, via the SBFD symbol, the one or more downlink messages or the one or more uplink messages in accordance with one or more SBFD collision rules.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for resolving SBFD time domain collisions, which may result in reduced processing, reduced power consumption, and more efficient utilization of communication resources, among other advantages.

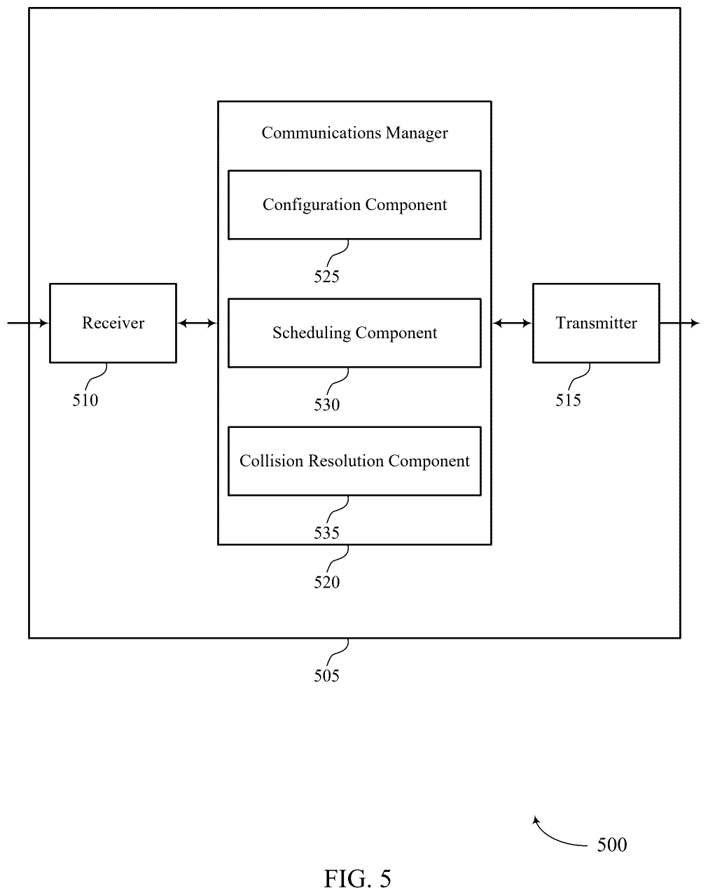

FIG. 5 shows a block diagram 500 of a device 505 that supports techniques for resolving SBFD time domain collisions in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for resolving SBFD time domain collisions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for resolving SBFD time domain collisions). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for resolving SBFD time domain collisions as described herein. For example, the communications manager 520 may include a configuration component 525, a scheduling component 530, a collision resolution component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The configuration component 525 is capable of, configured to, or operable to support a means for receive a configuration message indicating one or more sub-band full-duplex (SBFD) symbols for a network entity, where each SBFD symbol of the one or more SBFD symbols includes one or more uplink sub-bands and one or more downlink sub-bands. The scheduling component 530 is capable of, configured to, or operable to support a means for receiving one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The collision resolution component 535 is capable of, configured to, or operable to support a means for communicating, via the SBFD symbol, the one or more downlink messages or the one or more uplink messages in accordance with one or more SBFD collision rules.

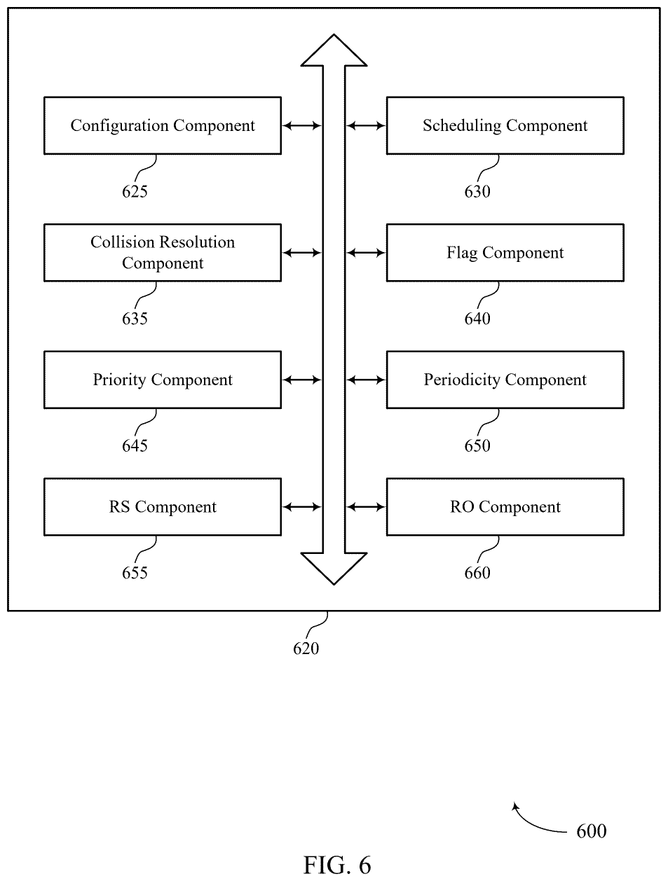

FIG. 6 shows a block diagram 600 of a communications manager 620 that supports techniques for resolving SBFD time domain collisions in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for resolving SBFD time domain collisions as described herein. For example, the communications manager 620 may include a configuration component 625, a scheduling component 630, a collision resolution component 635, a flag component 640, a priority component 645, a periodicity component 650, an RS component 655, a RO component 660, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The configuration component 625 is capable of, configured to, or operable to support a means for receive a configuration message indicating one or more sub-band full-duplex (SBFD) symbols for a network entity, where each SBFD symbol of the one or more SBFD symbols includes one or more uplink sub-bands and one or more downlink sub-bands. The scheduling component 630 is capable of, configured to, or operable to support a means for receiving one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The collision resolution component 635 is capable of, configured to, or operable to support a means for communicating, via the SBFD symbol, the one or more downlink messages or the one or more uplink messages in accordance with one or more SBFD collision rules.

In some examples, to support communicating the one or more downlink messages or the one or more uplink messages, the collision resolution component 635 is capable of, configured to, or operable to support a means for receiving the one or more downlink messages based on the one or more SBFD collision rules indicating for the UE to prioritize the one or more downlink messages. In some examples, to support communicating the one or more downlink messages or the one or more uplink messages, the collision resolution component 635 is capable of, configured to, or operable to support a means for transmitting the one or more uplink messages based on the one or more SBFD collision rules indicating for the UE to prioritize the one or more uplink messages.

In some examples, both the one or more downlink messages and the one or more uplink messages are semi-statically configured.

In some examples, the one or more downlink messages include one or more SSB reference signals and the one or more uplink messages are dynamically scheduled or semi-statically configured or semi-persistently configured.

In some examples, the one or more downlink messages are dynamically scheduled or semi-statically configured or semi-persistently configured and the one or more uplink messages are associated with one or more ROs.

In some examples, to support communicating the one or more downlink messages or the one or more uplink messages, the collision resolution component 635 is capable of, configured to, or operable to support a means for communicating the one or more downlink messages or the one or more uplink messages based on whether the SBFD symbol is configured on the downlink symbol or on the flexible symbol.

In some examples, to support communicating the one or more downlink messages or the one or more uplink messages, the collision resolution component 635 is capable of, configured to, or operable to support a means for receiving the one or more downlink messages based on the SBFD symbol being configured on the downlink symbol. In some examples, to support communicating the one or more downlink messages or the one or more uplink messages, the collision resolution component 635 is capable of, configured to, or operable to support a means for transmitting the one or more uplink messages based on the SBFD symbol being configured on the flexible symbol.

In some examples, to support communicating the one or more downlink messages or the one or more uplink messages, the flag component 640 is capable of, configured to, or operable to support a means for communicating the one or more downlink messages or the one or more uplink messages based on whether the one or more downlink messages or the one or more uplink messages includes the flag.

In some examples, to support communicating the one or more downlink messages or the one or more uplink messages, the flag component 640 is capable of, configured to, or operable to support a means for receiving the one or more downlink messages based on the one or more downlink messages including the flag. In some examples, to support communicating the one or more downlink messages or the one or more uplink messages, the flag component 640 is capable of, configured to, or operable to support a means for transmitting the one or more uplink messages based on the one or more uplink messages including the flag.

In some examples, to support communicating the one or more downlink messages or the one or more uplink messages, the priority component 645 is capable of, configured to, or operable to support a means for communicating the one or more downlink messages or the one or more uplink messages based on whether the one or more downlink messages or the one or more uplink messages are associated with the higher priority.

In some examples, to support communicating the one or more downlink messages or the one or more uplink messages, the priority component 645 is capable of, configured to, or operable to support a means for receiving the one or more downlink messages based on the first priority being greater than the second priority. In some examples, to support communicating the one or more downlink messages or the one or more uplink messages, the priority component 645 is capable of, configured to, or operable to support a means for transmitting the one or more uplink messages based on the second priority being greater than the first priority.

In some examples, priority is defined per message. In some examples, each of the first priority and the second priority are indicated via at least one bit.

In some examples, the first priority is based on a downlink channel associated with the one or more downlink messages. In some examples, the second priority is based on an uplink channel associated with the one or more uplink messages. In some examples, the UE determines which of the first priority and the second priority is the higher priority based on a table comparing the downlink channel and the uplink channel.

In some examples, to support communicating the one or more downlink messages or the one or more uplink messages, the priority component 645 is capable of, configured to, or operable to support a means for communicating the one or more downlink messages or the one or more uplink messages based on the channel priority order.

In some examples, to support communicating the one or more downlink messages or the one or more uplink messages, the priority component 645 is capable of, configured to, or operable to support a means for receiving the one or more downlink messages based on the first channel being associated with a higher priority than the second channel in accordance with the channel priority order. In some examples, to support communicating the one or more downlink messages or the one or more uplink messages, the priority component 645 is capable of, configured to, or operable to support a means for transmitting the one or more uplink messages based on the second channel being associated with a higher priority than the first channel in accordance with the channel priority order.

In some examples, the channel priority order includes SSBs, ROs, PDCCHs, PUSCHs, PDSCHs, PUSCHs, CSI-RS, and SRS, as ordered from highest priority to lowest priority.

In some examples, the channel priority order includes AP PRACHs, AP PUSCHs, DG-PDSCHs, DG-PUSCHs, AP CSI-RS, and AP SRS, as ordered from highest priority to lowest priority.

In some examples, to support communicating the one or more downlink messages or the one or more uplink messages, the periodicity component 650 is capable of, configured to, or operable to support a means for communicating the one or more downlink messages or the one or more uplink messages based on the comparison between the first transmission periodicity and the second transmission periodicity.

In some examples, an SP transmission periodicity is associated with a higher priority than a P transmission periodicity.

In some examples, to support communicating the one or more downlink messages or the one or more uplink messages, the collision resolution component 635 is capable of, configured to, or operable to support a means for communicating the one or more downlink messages or the one or more uplink messages based on the one or more conditions associated with the UE.

In some examples, the one or more conditions may be based on prioritizing uplink coverage, prioritizing uplink latency, prioritizing MO, prioritizing TRS, or any combination thereof.

In some examples, the one or more downlink messages are associated with a first channel and the one or more uplink messages are associated with a second channel. In some examples, the one or more SBFD collision rules are based on a channel pair including the first channel and the second channel.

In some examples, to support communicating the one or more downlink messages or the one or more uplink messages, the scheduling component 630 is capable of, configured to, or operable to support a means for communicating the one or more downlink messages or the one or more uplink messages based on comparisons between a threshold scheduling offset and each of the first scheduling offset and the second scheduling offset.

In some examples, to support communicating the one or more downlink messages or the one or more uplink messages, the scheduling component 630 is capable of, configured to, or operable to support a means for receiving the one or more downlink messages based on the first scheduling offset being less than the threshold scheduling offset and the second scheduling offset being greater than the threshold scheduling offset.

In some examples, communicating the one or more downlink messages or the one or more uplink messages in accordance with the one or more SBFD collision rules is based on both the first scheduling offset and the second scheduling offset being greater than the threshold scheduling offset.

In some examples, to support receiving the one or more control messages scheduling the one or more downlink messages and the one or more uplink messages, the scheduling component 630 is capable of, configured to, or operable to support a means for receiving, at a first time, a first control message scheduling the one or more downlink messages. In some examples, to support receiving the one or more control messages scheduling the one or more downlink messages and the one or more uplink messages, the scheduling component 630 is capable of, configured to, or operable to support a means for receiving, at a second time, a second control message scheduling the one or more uplink messages, where the one or more SBFD collision rules indicate for the UE to communicate the one or more downlink messages or the one or more uplink messages based on a comparison between the first time and the second time.

In some examples, to support communicating the one or more downlink messages or the one or more uplink messages, the scheduling component 630 is capable of, configured to, or operable to support a means for receiving the one or more downlink messages based on the first time being after the second time. In some examples, to support communicating the one or more downlink messages or the one or more uplink messages, the scheduling component 630 is capable of, configured to, or operable to support a means for transmitting the one or more uplink messages based on the first time being before the second time.

In some examples, to support communicating the one or more downlink messages or the one or more uplink messages, the RS component 655 is capable of, configured to, or operable to support a means for receiving the one or more downlink SSB reference signals via the SBFD symbol based on the one or more downlink messages including the one or more downlink SSB reference signals.

In some examples, to support communicating the one or more downlink messages or the one or more uplink messages, the RO component 660 is capable of, configured to, or operable to support a means for transmitting the one or more uplink messages via the SBFD symbol based on the one or more uplink messages being associated with one or more ROs.

In some examples, the configuration component 625 is capable of, configured to, or operable to support a means for receiving a second control message indicating the one or more SBFD collision rules, where communicating the one or more downlink messages or the one or more uplink messages is based on receiving the second control message.

In some examples, the one or more downlink messages are dynamically scheduled or semi-statically configured or semi-persistently configured and the one or more uplink messages are associated with one or more ROs further associated with a random access procedure. In some examples, the one or more SBFD collision rules are based on whether the random access procedure was triggered dynamically or was triggered by RRC signaling.

In some examples, to support communicating the one or more downlink messages or the one or more uplink messages, the RO component 660 is capable of, configured to, or operable to support a means for transmitting the one or more uplink messages via the SBFD symbol based on the random access procedure being triggered dynamically via physical downlink control channel order and based on the one or more downlink messages being semi-statically configured.

In some examples, to support communicating the one or more downlink messages or the one or more uplink messages, the RO component 660 is capable of, configured to, or operable to support a means for receiving the one or more downlink messages via the SBFD symbol based on the random access procedure being triggered by the RRC signaling and based on the one or more downlink messages being dynamically configured via downlink control information.

In some examples, the UE does not expect for the random access procedure to be triggered dynamically via physical downlink control channel order and for the one or more downlink messages to be dynamically configured via downlink control information simultaneously.

In some examples, both the one or more downlink messages and the one or more uplink messages are semi-statically configured.

In some examples, both the one or more downlink messages and the one or more uplink messages are dynamically scheduled.

In some examples, the one or more downlink messages include one or more SSB reference signals and the one or more uplink messages are dynamically scheduled or semi-statically configured or semi-persistently configured.

In some examples, the one or more downlink messages are dynamically scheduled or semi-statically configured or semi-persistently configured and the one or more uplink messages are associated with one or more ROs.

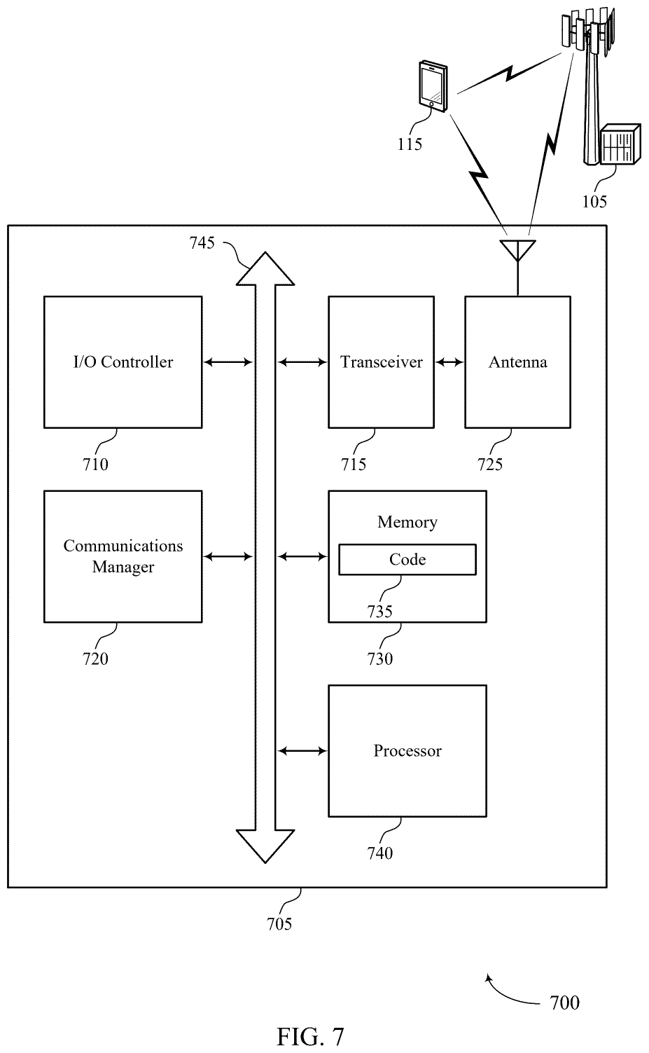

FIG. 7 shows a diagram of a system 700 including a device 705 that supports techniques for resolving SBFD time domain collisions in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for resolving SBFD time domain collisions). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The communications manager 720 is capable of, configured to, or operable to support a means for receiving one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The communications manager 720 is capable of, configured to, or operable to support a means for communicating, via the SBFD symbol, the one or more downlink messages or the one or more uplink messages in accordance with one or more SBFD collision rules.

By including or configuring the communications manager 720 in accordance with examples as described herein, the device 705 may support techniques for resolving SBFD time domain collisions, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for resolving SBFD time domain collisions as described herein, or the at least one processor 740 and the at least one memory 730 may be otherwise configured to, individually or collectively, perform or support such operations.

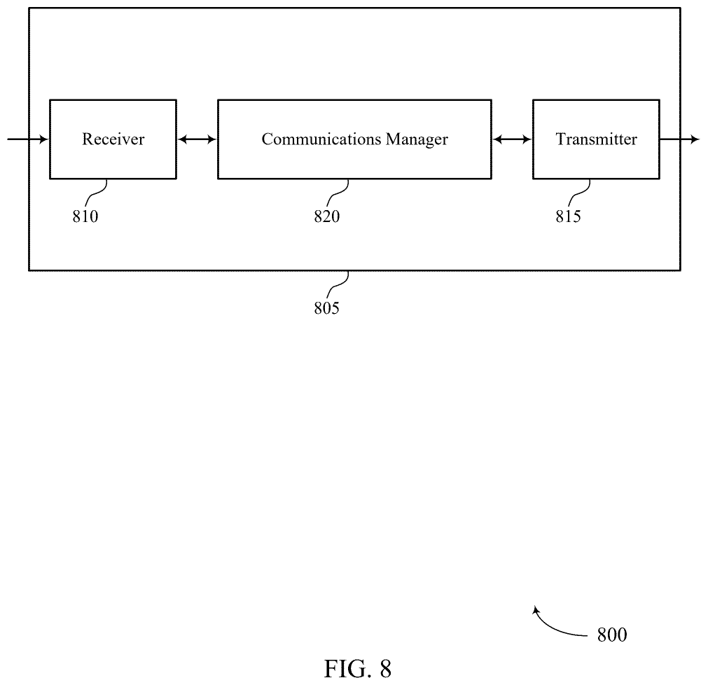

FIG. 8 shows a block diagram 800 of a device 805 that supports techniques for resolving SBFD time domain collisions in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for resolving SBFD time domain collisions as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting, to a half-duplex UE, a configuration message indicating one or more sub-band full-duplex (SBFD) symbols for the network entity, where each SBFD symbol of the one or more SBFD symbols includes one or more uplink sub-bands and one or more downlink sub-bands. The communications manager 820 is capable of, configured to, or operable to support a means for transmitting one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The communications manager 820 is capable of, configured to, or operable to support a means for communicating, via the SBFD symbol, the one or more downlink messages or the one or more uplink messages in accordance with one or more SBFD collision rules.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for resolving SBFD time domain collisions, which may result in reduced processing, reduced power consumption, and more efficient utilization of communication resources, among other advantages.

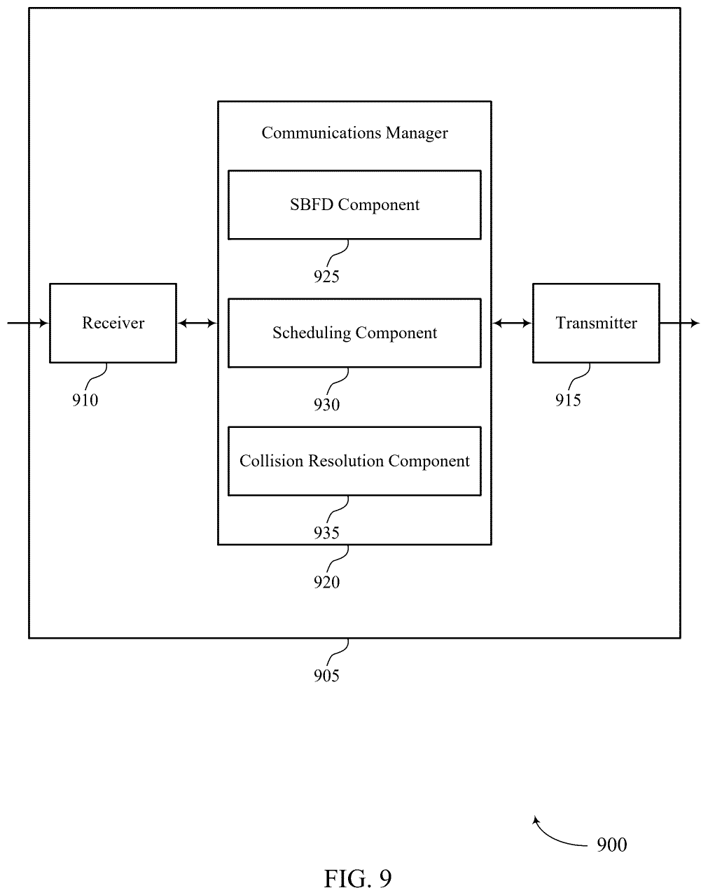

FIG. 9 shows a block diagram 900 of a device 905 that supports techniques for resolving SBFD time domain collisions in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for resolving SBFD time domain collisions as described herein. For example, the communications manager 920 may include an SBFD component 925, a scheduling component 930, a collision resolution component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The SBFD component 925 is capable of, configured to, or operable to support a means for transmitting, to a half-duplex UE, a configuration message indicating one or more sub-band full-duplex (SBFD) symbols for the network entity, where each SBFD symbol of the one or more SBFD symbols includes one or more uplink sub-bands and one or more downlink sub-bands. The scheduling component 930 is capable of, configured to, or operable to support a means for transmitting one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The collision resolution component 935 is capable of, configured to, or operable to support a means for communicating, via the SBFD symbol, the one or more downlink messages or the one or more uplink messages in accordance with one or more SBFD collision rules.

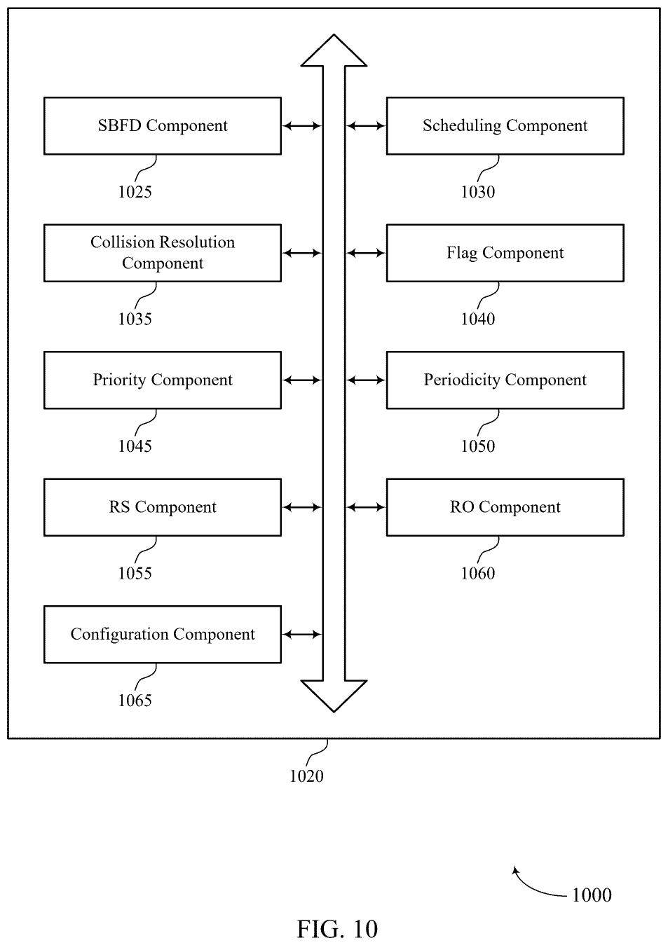

FIG. 10 shows a block diagram 1000 of a communications manager 1020 that supports techniques for resolving SBFD time domain collisions in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for resolving SBFD time domain collisions as described herein. For example, the communications manager 1020 may include an SBFD component 1025, a scheduling component 1030, a collision resolution component 1035, a flag component 1040, a priority component 1045, a periodicity component 1050, an RS component 1055, a RO component 1060, a configuration component 1065, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The SBFD component 1025 is capable of, configured to, or operable to support a means for transmitting, to a half-duplex UE, a configuration message indicating one or more sub-band full-duplex (SBFD) symbols for the network entity, where each SBFD symbol of the one or more SBFD symbols includes one or more uplink sub-bands and one or more downlink sub-bands. The scheduling component 1030 is capable of, configured to, or operable to support a means for transmitting one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The collision resolution component 1035 is capable of, configured to, or operable to support a means for communicating, via the SBFD symbol, the one or more downlink messages or the one or more uplink messages in accordance with one or more SBFD collision rules.

In some examples, to support communicating the one or more downlink messages or the one or more uplink messages, the collision resolution component 1035 is capable of, configured to, or operable to support a means for transmitting the one or more downlink messages based on the one or more SBFD collision rules indicating for the UE to prioritize the one or more downlink messages. In some examples, to support communicating the one or more downlink messages or the one or more uplink messages, the collision resolution component 1035 is capable of, configured to, or operable to support a means for receiving the one or more uplink messages based on the one or more SBFD collision rules indicating for the UE to prioritize the one or more uplink messages.

In some examples, both the one or more downlink messages and the one or more uplink messages are semi-statically configured.

In some examples, the one or more downlink messages include one or more SSB reference signals and the one or more uplink messages are dynamically scheduled or semi-statically configured or semi-persistently configured.

In some examples, the one or more downlink messages are dynamically scheduled or semi-statically configured or semi-persistently configured and the one or more uplink messages are associated with one or more ROs.

In some examples, to support communicating the one or more downlink messages or the one or more uplink messages, the collision resolution component 1035 is capable of, configured to, or operable to support a means for communicating the one or more downlink messages or the one or more uplink messages based on whether the SBFD symbol is configured on the downlink symbol or on the flexible symbol.

In some examples, to support communicating the one or more downlink messages or the one or more uplink messages, the collision resolution component 1035 is capable of, configured to, or operable to support a means for transmitting the one or more downlink messages based on the SBFD symbol being configured on the downlink symbol. In some examples, to support communicating the one or more downlink messages or the one or more uplink messages, the collision resolution component 1035 is capable of, configured to, or operable to support a means for receiving the one or more uplink messages based on the SBFD symbol being configured on the flexible symbol.

In some examples, to support communicating the one or more downlink messages or the one or more uplink messages, the flag component 1040 is capable of, configured to, or operable to support a means for communicating the one or more downlink messages or the one or more uplink messages based on whether the one or more downlink messages or the one or more uplink messages includes the flag.

In some examples, to support communicating the one or more downlink messages or the one or more uplink messages, the flag component 1040 is capable of, configured to, or operable to support a means for transmitting the one or more downlink messages based on the one or more downlink messages including the flag. In some examples, to support communicating the one or more downlink messages or the one or more uplink messages, the flag component 1040 is capable of, configured to, or operable to support a means for receiving the one or more uplink messages based on the one or more uplink messages including the flag.

In some examples, to support communicating the one or more downlink messages or the one or more uplink messages, the priority component 1045 is capable of, configured to, or operable to support a means for communicating the one or more downlink messages or the one or more uplink messages based on whether the one or more downlink messages or the one or more uplink messages are associated with the higher priority.

In some examples, to support communicating the one or more downlink messages or the one or more uplink messages, the priority component 1045 is capable of, configured to, or operable to support a means for transmitting the one or more downlink messages based on the first priority being greater than the second priority. In some examples, to support communicating the one or more downlink messages or the one or more uplink messages, the priority component 1045 is capable of, configured to, or operable to support a means for receiving the one or more uplink messages based on the second priority being greater than the first priority.

In some examples, priority is defined per message. In some examples, each of the first priority and the second priority are indicated via at least one bit.

In some examples, the first priority is based on a downlink channel associated with the one or more downlink messages. In some examples, the second priority is based on an uplink channel associated with the one or more uplink messages. In some examples, the network entity determines which of the first priority and the second priority is the higher priority based on a table comparing the downlink channel and the uplink channel.

In some examples, to support communicating the one or more downlink messages or the one or more uplink messages, the priority component 1045 is capable of, configured to, or operable to support a means for communicating the one or more downlink messages or the one or more uplink messages based on the channel priority order.

In some examples, to support communicating the one or more downlink messages or the one or more uplink messages, the priority component 1045 is capable of, configured to, or operable to support a means for transmitting the one or more downlink messages based on the first channel being associated with a higher priority than the second channel in accordance with the channel priority order. In some examples, to support communicating the one or more downlink messages or the one or more uplink messages, the priority component 1045 is capable of, configured to, or operable to support a means for receiving the one or more uplink messages based on the second channel being associated with a higher priority than the first channel in accordance with the channel priority order.

In some examples, the channel priority order includes SSBs, ROs, PDCCHs, PUSCHs, PDSCHs, PUSCHs, CSI-RS, and SRS, as ordered from highest priority to lowest priority.

In some examples, the channel priority order includes AP PRACHs, AP PUSCHs, DG-PDSCHs, DG-PUSCHs, AP CSI-RS, and AP SRS, as ordered from highest priority to lowest priority.

In some examples, to support communicating the one or more downlink messages or the one or more uplink messages, the periodicity component 1050 is capable of, configured to, or operable to support a means for communicating the one or more downlink messages or the one or more uplink messages based on the comparison between the first transmission periodicity and the second transmission periodicity.

In some examples, an SP transmission periodicity is associated with a higher priority than a P transmission periodicity.

In some examples, to support communicating the one or more downlink messages or the one or more uplink messages, the collision resolution component 1035 is capable of, configured to, or operable to support a means for communicating the one or more downlink messages or the one or more uplink messages based on the one or more conditions associated with the UE.

In some examples, the one or more conditions may be based on prioritizing uplink coverage, prioritizing uplink latency, prioritizing MO, prioritizing TRS, or any combination thereof.

In some examples, the one or more downlink messages are associated with a first channel and the one or more uplink messages are associated with a second channel. In some examples, the one or more SBFD collision rules are based on a channel pair including the first channel and the second channel.

In some examples, to support communicating the one or more downlink messages or the one or more uplink messages, the scheduling component 1030 is capable of, configured to, or operable to support a means for communicating the one or more downlink messages or the one or more uplink messages based on comparisons between a threshold scheduling offset and each of the first scheduling offset and the second scheduling offset.

In some examples, to support communicating the one or more downlink messages or the one or more uplink messages, the scheduling component 1030 is capable of, configured to, or operable to support a means for transmitting the one or more downlink messages based on the first scheduling offset being less than the threshold scheduling offset and the second scheduling offset being greater than the threshold scheduling offset.

In some examples, communicating the one or more downlink messages or the one or more uplink messages in accordance with the one or more SBFD collision rules is based on both the first scheduling offset and the second scheduling offset being greater than the threshold scheduling offset.

In some examples, to support transmitting the one or more control messages scheduling the one or more downlink messages and the one or more uplink messages, the scheduling component 1030 is capable of, configured to, or operable to support a means for transmitting, at a first time, a first control message scheduling the one or more downlink messages. In some examples, to support transmitting the one or more control messages scheduling the one or more downlink messages and the one or more uplink messages, the scheduling component 1030 is capable of, configured to, or operable to support a means for transmitting, at a second time, a second control message scheduling the one or more uplink messages, where the one or more SBFD collision rules indicate for the network entity to communicate the one or more downlink messages or the one or more uplink messages based on a comparison between the first time and the second time.

In some examples, to support communicating the one or more downlink messages or the one or more uplink messages, the scheduling component 1030 is capable of, configured to, or operable to support a means for transmitting the one or more downlink messages based on the first time being after the second time. In some examples, to support communicating the one or more downlink messages or the one or more uplink messages, the scheduling component 1030 is capable of, configured to, or operable to support a means for receiving the one or more uplink messages based on the first time being before the second time.

In some examples, to support communicating the one or more downlink messages or the one or more uplink messages, the RS component 1055 is capable of, configured to, or operable to support a means for transmitting the one or more downlink SSB reference signals via the SBFD symbol based on the one or more downlink messages including the one or more downlink SSB reference signals.

In some examples, to support communicating the one or more downlink messages or the one or more uplink messages, the RO component 1060 is capable of, configured to, or operable to support a means for receiving the one or more uplink messages via the SBFD symbol based on the one or more uplink messages being associated with one or more ROs.

In some examples, the configuration component 1065 is capable of, configured to, or operable to support a means for transmitting a second control message indicating the one or more SBFD collision rules, where communicating the one or more downlink messages or the one or more uplink messages is based on receiving the second control message.

In some examples, the one or more downlink messages are dynamically scheduled or semi-statically configured or semi-persistently configured and the one or more uplink messages are associated with one or more ROs. In some examples, the one or more uplink messages are associated with one or more ROs further associated with a random access procedure. In some examples, the one or more SBFD collision rules are based on whether the random access procedure was triggered dynamically or was triggered by RRC signaling.

In some examples, to support communicating the one or more downlink messages or the one or more uplink messages, the RO component 1060 is capable of, configured to, or operable to support a means for receiving the one or more uplink messages via the SBFD symbol based on the random access procedure being triggered dynamically via physical downlink control channel order and based on the one or more downlink messages being semi-statically configured.

In some examples, to support communicating the one or more downlink messages or the one or more uplink messages, the RO component 1060 is capable of, configured to, or operable to support a means for transmitting the one or more downlink messages via the SBFD symbol based on the random access procedure being triggered by the RRC signaling and based on the one or more downlink messages being dynamically configured via downlink control information.

In some examples, the network entity does not schedule the random access procedure to be triggered dynamically via physical downlink control channel order and the one or more downlink messages to be dynamically configured via downlink control information simultaneously.

In some examples, communicating the one or more downlink messages or the one or more uplink messages in accordance with the one or more SBFD collision rules is based on the random access procedure being triggered by the RRC signaling and based on the one or more downlink messages being semi-statically configured.

In some examples, both the one or more downlink messages and the one or more uplink messages are semi-statically configured.

In some examples, both the one or more downlink messages and the one or more uplink messages are dynamically scheduled.

In some examples, the one or more downlink messages include one or more SSB reference signals and the one or more uplink messages are dynamically scheduled or semi-statically configured or semi-persistently configured.

In some examples, the one or more downlink messages are dynamically scheduled or semi-statically configured or semi-persistently configured and the one or more uplink messages are associated with one or more ROs.

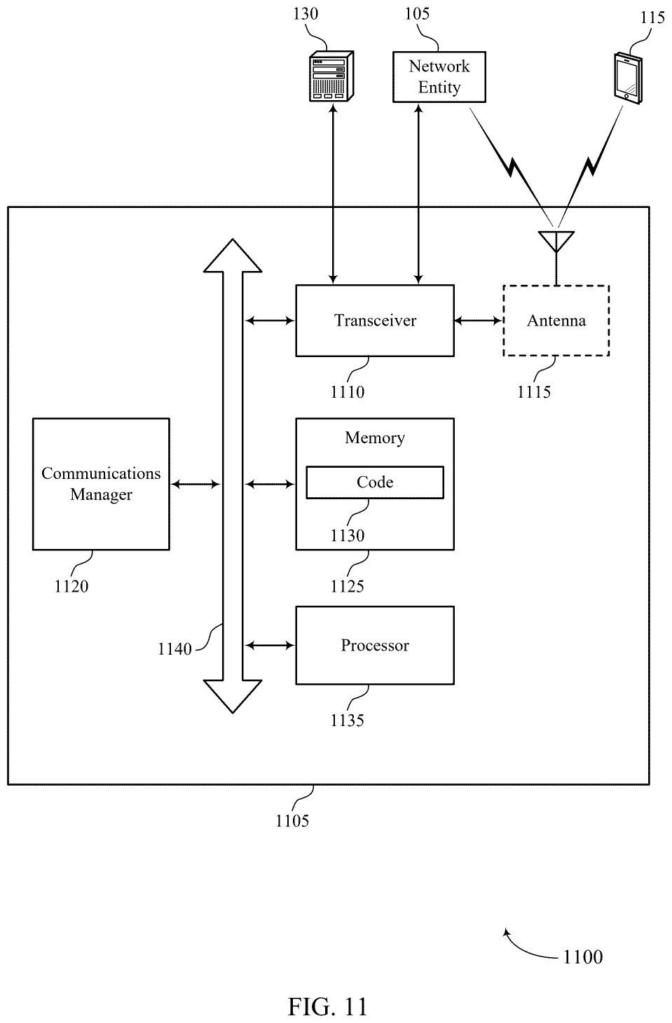

FIG. 11 shows a diagram of a system 1100 including a device 1105 that supports techniques for resolving SBFD time domain collisions in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for resolving SBFD time domain collisions). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting, to a half-duplex UE, a configuration message indicating one or more sub-band full-duplex (SBFD) symbols for the network entity, where each SBFD symbol of the one or more SBFD symbols includes one or more uplink sub-bands and one or more downlink sub-bands. The communications manager 1120 is capable of, configured to, or operable to support a means for transmitting one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The communications manager 1120 is capable of, configured to, or operable to support a means for communicating, via the SBFD symbol, the one or more downlink messages or the one or more uplink messages in accordance with one or more SBFD collision rules.

By including or configuring the communications manager 1120 in accordance with examples as described herein, the device 1105 may support techniques for resolving SBFD time domain collisions, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for resolving SBFD time domain collisions as described herein, or the at least one processor 1135 and the at least one memory 1125 may be otherwise configured to, individually or collectively, perform or support such operations.

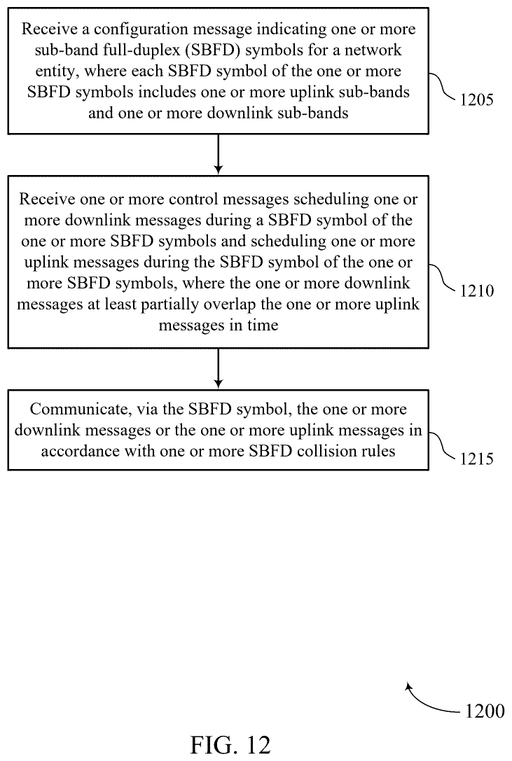

FIG. 12 shows a flowchart illustrating a method 1200 that supports techniques for resolving SBFD time domain collisions in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receive a configuration message indicating one or more sub-band full-duplex (SBFD) symbols for a network entity, where each SBFD symbol of the one or more SBFD symbols includes one or more uplink sub-bands and one or more downlink sub-bands. The operations of 1205 may be performed in accordance with examples as disclosed herein. In some examples, aspects of the operations of 1205 may be performed by a configuration component 625 as described with reference to FIG. 6.

At 1210, the method may include receiving one or more control messages scheduling one or more downlink messages during a SBFD symbol of the one or more SBFD symbols and scheduling one or more uplink messages during the SBFD symbol of the one or more SBFD symbols, where the one or more downlink messages at least partially overlap the one or more uplink messages in time. The operations of 1210 may be performed in accordance with examples as disclosed herein. In some examples, aspects of the operations of 1210 may be performed by a scheduling component 630 as described with reference to FIG. 6.

At 1215, the method may include communicating, via the SBFD symbol, the one or more downlink messages or the one or more uplink messages in accordance with one or more SBFD collision rules. The operations of 1215 may be performed in accordance with examples as disclosed herein. In some examples, aspects of the operations of 1215 may be performed by a collision resolution component 635 as described with reference to FIG. 6.

The following provides an overview of aspects of the present disclosure:

Aspect 1: A method for wireless communications at a half-duplex UE, comprising: receive a configuration message indicating one or more SBFD symbols for a network entity, wherein each SBFD symbol of the one or more SBFD symbols comprises one or more uplink sub-bands and one or more downlink sub-bands; receiving one or more control messages scheduling one or more downlink messages during a SBFD symbol of the one or more SBFD symbols and scheduling one or more uplink messages during the SBFD symbol of the one or more SBFD symbols, wherein the one or more downlink messages at least partially overlap the one or more uplink messages in time; and communicating, via the SBFD symbol, the one or more downlink messages or the one or more uplink messages in accordance with one or more SBFD collision rules.

Aspect 2: The method of aspect 1, wherein communicating the one or more downlink messages or the one or more uplink messages comprises: receiving the one or more downlink messages based at least in part on the one or more SBFD collision rules indicating for the UE to prioritize the one or more downlink messages; or transmitting the one or more uplink messages based at least in part on the one or more SBFD collision rules indicating for the UE to prioritize the one or more uplink messages.

Aspect 3: The method of aspect 2, wherein both the one or more downlink messages and the one or more uplink messages are semi-statically configured.

Aspect 4: The method of any of aspects 2 through 3, wherein the one or more downlink messages comprise one or more synchronization signal block reference signals and the one or more uplink messages are dynamically scheduled or semi-statically configured or semi-persistently configured.

Aspect 5: The method of any of aspects 2 through 4, wherein the one or more downlink messages are dynamically scheduled or semi-statically configured or semi-persistently configured and the one or more uplink messages are associated with one or more random access occasions.

Aspect 6: The method of any of aspects 1 through 5, wherein the one or more SBFD collision rules indicate for the UE to transmit the one or more uplink messages based at least in part on whether the SBFD symbol is configured on a downlink symbol or on a flexible symbol, and wherein communicating the one or more downlink messages or the one or more uplink messages comprises: communicating the one or more downlink messages or the one or more uplink messages based at least in part on whether the SBFD symbol is configured on the downlink symbol or on the flexible symbol.

Aspect 7: The method of aspect 6, wherein communicating the one or more downlink messages or the one or more uplink messages comprises: receiving the one or more downlink messages based at least in part on the SBFD symbol being configured on the downlink symbol; or transmitting the one or more uplink messages based at least in part on the SBFD symbol being configured on the flexible symbol.

Aspect 8: The method of any of aspects 1 through 7, wherein the one or more SBFD collision rules indicate for the UE to communicate the one or more downlink messages or the one or more uplink messages based at least in part on whether the one or more downlink messages or the one or more uplink messages comprises a flag, and wherein communicating the one or more downlink messages or the one or more uplink messages comprises: communicating the one or more downlink messages or the one or more uplink messages based at least in part on whether the one or more downlink messages or the one or more uplink messages comprises the flag.

Aspect 9: The method of aspect 8, wherein communicating the one or more downlink messages or the one or more uplink messages comprises: receiving the one or more downlink messages based at least in part on the one or more downlink messages comprising the flag; or transmitting the one or more uplink messages based at least in part on the one or more uplink messages comprising the flag.

Aspect 10: The method of any of aspects 1 through 9, wherein the one or more SBFD collision rules indicate for the UE to communicate the one or more downlink messages or the one or more uplink messages based at least in part on whether the one or more downlink messages or the one or more uplink messages are associated with a higher priority, and wherein communicating the one or more downlink messages or the one or more uplink messages comprises: communicating the one or more downlink messages or the one or more uplink messages based at least in part on whether the one or more downlink messages or the one or more uplink messages are associated with the higher priority.

Aspect 11: The method of aspect 10, wherein the one or more downlink messages are associated with a first priority and the one or more uplink messages are associated with a second priority, and wherein communicating the one or more downlink messages or the one or more uplink messages comprises: receiving the one or more downlink messages based at least in part on the first priority being greater than the second priority; or transmitting the one or more uplink messages based at least in part on the second priority being greater than the first priority.

Aspect 12: The method of aspect 11, wherein priority is defined per message, and each of the first priority and the second priority are indicated via at least one bit.

Aspect 13: The method of any of aspects 11 through 12, wherein the first priority is based at least in part on a downlink channel associated with the one or more downlink messages, the second priority is based at least in part on an uplink channel associated with the one or more uplink messages, and the UE determines which of the first priority and the second priority is the higher priority based at least in part on a table comparing the downlink channel and the uplink channel.

Aspect 14: The method of any of aspects 1 through 13, wherein the one or more SBFD collision rules indicate for the UE to communicate the one or more downlink messages or the one or more uplink messages based at least in part on a channel priority order, and wherein communicating the one or more downlink messages or the one or more uplink messages comprises: communicating the one or more downlink messages or the one or more uplink messages based at least in part on the channel priority order.

Aspect 15: The method of aspect 14, wherein the one or more downlink messages are associated with a first channel and the one or more uplink messages are associated with a second channel, and wherein communicating the one or more downlink messages or the one or more uplink messages comprises: receiving the one or more downlink messages based at least in part on the first channel being associated with a higher priority than the second channel in accordance with the channel priority order; or transmitting the one or more uplink messages based at least in part on the second channel being associated with a higher priority than the first channel in accordance with the channel priority order.

Aspect 16: The method of any of aspects 14 through 15, wherein the channel priority order comprises synchronization signal blocks, random access occasions, physical downlink control channels, physical uplink control channels, physical downlink shared channels, physical uplink shared channels, channel state information reference signals, and sounding reference signals, as ordered from highest priority to lowest priority.

Aspect 17: The method of any of aspects 14 through 16, wherein the channel priority order comprises aperiodic physical random access channels, aperiodic physical uplink control channels, dynamic grant physical downlink shared channels, dynamic grant physical uplink shared channels, aperiodic channel state information reference signals, and aperiodic sounding reference signals, as ordered from highest priority to lowest priority.

Aspect 18: The method of any of aspects 1 through 17, wherein the one or more downlink messages are associated with a first transmission periodicity and the one or more uplink messages are associated with a second transmission periodicity, wherein the one or more SBFD collision rules indicate for the UE to communicate the one or more downlink messages or the one or more uplink messages based at least in part on a comparison between the first transmission periodicity and the second transmission periodicity, and wherein communicating the one or more downlink messages or the one or more uplink messages comprises: communicating the one or more downlink messages or the one or more uplink messages based at least in part on the comparison between the first transmission periodicity and the second transmission periodicity.

Aspect 19: The method of aspect 18, wherein a semi-persistent transmission periodicity is associated with a higher priority than a periodic transmission periodicity.

Aspect 20: The method of any of aspects 1 through 19, wherein the one or more SBFD collision rules indicate for the UE to communicate the one or more downlink messages or the one or more uplink messages based at least in part on one or more conditions associated with the UE, and wherein communicating the one or more downlink messages or the one or more uplink messages comprises: communicating the one or more downlink messages or the one or more uplink messages based at least in part on the one or more conditions associated with the UE.

Aspect 21: The method of aspect 20, wherein the one or more conditions may be based on prioritizing uplink coverage, prioritizing uplink latency, prioritizing monitoring occasions, prioritizing tracking reference signals, or any combination thereof.

Aspect 22: The method of any of aspects 1 through 21, wherein the one or more downlink messages are associated with a first channel and the one or more uplink messages are associated with a second channel, and the one or more SBFD collision rules are based at least in part on a channel pair including the first channel and the second channel.

Aspect 23: The method of any of aspects 1 through 22, wherein both the one or more downlink messages and the one or more uplink messages are dynamically scheduled, wherein the one or more downlink messages are associated with a first scheduling offset and the one or more uplink messages are associated with a second scheduling offset, and wherein communicating the one or more downlink messages or the one or more uplink messages comprises: communicating the one or more downlink messages or the one or more uplink messages based at least in part on comparisons between a threshold scheduling offset and each of the first scheduling offset and the second scheduling offset.

Aspect 24: The method of aspect 23, wherein the one or more SBFD collision rules indicate for the UE to receive the one or more downlink messages based at least in part on the first scheduling offset being less than the threshold scheduling offset and the second scheduling offset being greater than the threshold scheduling offset, and wherein communicating the one or more downlink messages or the one or more uplink messages comprises: receiving the one or more downlink messages based at least in part on the first scheduling offset being less than the threshold scheduling offset and the second scheduling offset being greater than the threshold scheduling offset.

Aspect 25: The method of any of aspects 23 through 24, wherein communicating the one or more downlink messages or the one or more uplink messages in accordance with the one or more SBFD collision rules is based at least in part on both the first scheduling offset and the second scheduling offset being greater than the threshold scheduling offset.

Aspect 26: The method of any of aspects 1 through 25, wherein receiving the one or more control messages scheduling the one or more downlink messages and the one or more uplink messages comprises: receiving, at a first time, a first control message scheduling the one or more downlink messages; and receiving, at a second time, a second control message scheduling the one or more uplink messages, wherein the one or more SBFD collision rules indicate for the UE to communicate the one or more downlink messages or the one or more uplink messages based at least in part on a comparison between the first time and the second time.

Aspect 27: The method of aspect 26, wherein the one or more SBFD collision rules indicate for the UE to communicate the one or more downlink messages or the one or more uplink messages based at least in part on a comparison between the first time and the second time, and wherein communicating the one or more downlink messages or the one or more uplink messages comprises: receiving the one or more downlink messages based at least in part on the first time being after the second time; or transmitting the one or more uplink messages based at least in part on the first time being before the second time.

Aspect 28: The method of any of aspects 1 through 27, wherein the one or more downlink messages comprise one or more downlink synchronization signal block reference signals and the one or more uplink messages are dynamically scheduled or semi-statically configured or semi-persistently configured, and wherein the one or more SBFD collision rules indicate for the UE to receive the one or more downlink messages based at least in part on the one or more downlink messages comprising the one or more downlink synchronization signal block reference signals, and wherein communicating the one or more downlink messages or the one or more uplink messages comprises: receiving the one or more downlink synchronization signal block reference signals via the SBFD symbol based at least in part on the one or more downlink messages comprising the one or more downlink synchronization signal block reference signals.

Aspect 29: The method of any of aspects 1 through 28, wherein the one or more downlink messages are dynamically scheduled or semi-statically configured or semi-persistently configured and the one or more uplink messages are associated with one or more random access occasions, and wherein the one or more SBFD collision rules indicate for the UE to transmit the one or more uplink messages based at least in part on the one or more uplink messages being associated with the one or more random access occasions, and wherein communicating the one or more downlink messages or the one or more uplink messages comprises: transmitting the one or more uplink messages via the SBFD symbol based at least in part on the one or more uplink messages being associated with one or more random access occasions.

Aspect 30: The method of any of aspects 1 through 29, further comprising: receiving a second control message indicating the one or more SBFD collision rules, wherein communicating the one or more downlink messages or the one or more uplink messages is based at least in part on receiving the second control message.

Aspect 31: The method of any of aspects 1 through 30, wherein the one or more downlink messages are dynamically scheduled or semi-statically configured or semi-persistently configured and the one or more uplink messages are associated with one or more random access occasions further associated with a random access procedure, and the one or more SBFD collision rules are based at least in part on whether the random access procedure was triggered dynamically or was triggered by radio resource control signaling.

Aspect 32: The method of aspect 31, wherein communicating the one or more downlink messages or the one or more uplink messages comprises: transmitting the one or more uplink messages via the SBFD symbol based at least in part on the random access procedure being triggered dynamically via physical downlink control channel order and based at least in part on the one or more downlink messages being semi-statically configured.

Aspect 33: The method of any of aspects 31 through 32, wherein communicating the one or more downlink messages or the one or more uplink messages comprises: receiving the one or more downlink messages via the SBFD symbol based at least in part on the random access procedure being triggered by the radio resource control signaling and based at least in part on the one or more downlink messages being dynamically configured via downlink control information.

Aspect 34: The method of any of aspects 31 through 33, wherein the UE does not expect for the random access procedure to be triggered dynamically via physical downlink control channel order and for the one or more downlink messages to be dynamically configured via downlink control information simultaneously.

Aspect 35: The method of any of aspects 31 through 34, herein communicating the one or more downlink messages or the one or more uplink messages in accordance with the one or more SBFD collision rules is based at least in part on the random access procedure being triggered by the radio resource control signaling and based at least in part on the one or more downlink messages being semi-statically configured.

Aspect 36: The method of any of aspects 1 through 35, wherein both the one or more downlink messages and the one or more uplink messages are semi-statically configured.

Aspect 37: The method of any of aspects 1 through 36, wherein both the one or more downlink messages and the one or more uplink messages are dynamically scheduled.

Aspect 38: The method of any of aspects 1 through 37, wherein the one or more downlink messages comprise one or more synchronization signal block reference signals and the one or more uplink messages are dynamically scheduled or semi-statically configured or semi-persistently configured.

Aspect 39: The method of any of aspects 1 through 38, wherein the one or more downlink messages are dynamically scheduled or semi-statically configured or semi-persistently configured and the one or more uplink messages are associated with one or more random access occasions.

Aspect 40: A method for wireless communications at a network entity, comprising: transmitting, to a half-duplex UE, a configuration message indicating one or more SBFD symbols for the network entity, wherein each SBFD symbol of the one or more SBFD symbols comprises one or more uplink sub-bands and one or more downlink sub-bands; transmitting one or more control messages scheduling one or more downlink messages during a SBFD symbol of the one or more SBFD symbols and scheduling one or more uplink messages during the SBFD symbol of the one or more SBFD symbols, wherein the one or more downlink messages at least partially overlap the one or more uplink messages in time; and communicating, via the SBFD symbol, the one or more downlink messages or the one or more uplink messages in accordance with one or more SBFD collision rules.

Aspect 41: The method of aspect 40, wherein communicating the one or more downlink messages or the one or more uplink messages comprises: transmitting the one or more downlink messages based at least in part on the one or more SBFD collision rules indicating for the UE to prioritize the one or more downlink messages; or receiving the one or more uplink messages based at least in part on the one or more SBFD collision rules indicating for the UE to prioritize the one or more uplink messages.

Aspect 42: The method of aspect 41, wherein both the one or more downlink messages and the one or more uplink messages are semi-statically configured.

Aspect 43: The method of any of aspects 41 through 42, wherein the one or more downlink messages comprise one or more synchronization signal block reference signals and the one or more uplink messages are dynamically scheduled or semi-statically configured or semi-persistently configured.

Aspect 44: The method of any of aspects 41 through 43, wherein the one or more downlink messages are dynamically scheduled or semi-statically configured or semi-persistently configured and the one or more uplink messages are associated with one or more random access occasions.

Aspect 45: The method of any of aspects 40 through 44, wherein the one or more SBFD collision rules indicate for the network entity to receive the one or more uplink messages based at least in part on whether the SBFD symbol is configured on a downlink symbol or on a flexible symbol, and wherein communicating the one or more downlink messages or the one or more uplink messages comprises: communicating the one or more downlink messages or the one or more uplink messages based at least in part on whether the SBFD symbol is configured on the downlink symbol or on the flexible symbol.

Aspect 46: The method of aspect 45, wherein communicating the one or more downlink messages or the one or more uplink messages comprises: transmitting the one or more downlink messages based at least in part on the SBFD symbol being configured on the downlink symbol; or receiving the one or more uplink messages based at least in part on the SBFD symbol being configured on the flexible symbol.

Aspect 47: The method of any of aspects 40 through 46, wherein the one or more SBFD collision rules indicate for the network entity to communicate the one or more downlink messages or the one or more uplink messages based at least in part on whether the one or more downlink messages or the one or more uplink messages comprises a flag, and wherein communicating the one or more downlink messages or the one or more uplink messages comprises: communicating the one or more downlink messages or the one or more uplink messages based at least in part on whether the one or more downlink messages or the one or more uplink messages comprises the flag.

Aspect 48: The method of aspect 47, wherein communicating the one or more downlink messages or the one or more uplink messages comprises: transmitting the one or more downlink messages based at least in part on the one or more downlink messages comprising the flag; or receiving the one or more uplink messages based at least in part on the one or more uplink messages comprising the flag.

Aspect 49: The method of any of aspects 40 through 48, wherein the one or more SBFD collision rules indicate for the network entity to communicate the one or more downlink messages or the one or more uplink messages based at least in part on whether the one or more downlink messages or the one or more uplink messages are associated with a higher priority, and wherein communicating the one or more downlink messages or the one or more uplink messages comprises: communicating the one or more downlink messages or the one or more uplink messages based at least in part on whether the one or more downlink messages or the one or more uplink messages are associated with the higher priority.

Aspect 50: The method of aspect 49, wherein the one or more downlink messages are associated with a first priority and the one or more uplink messages are associated with a second priority, and wherein communicating the one or more downlink messages or the one or more uplink messages comprises: transmitting the one or more downlink messages based at least in part on the first priority being greater than the second priority; or receiving the one or more uplink messages based at least in part on the second priority being greater than the first priority.

Aspect 51: The method of aspect 50, wherein priority is defined per message, and each of the first priority and the second priority are indicated via at least one bit.

Aspect 52: The method of any of aspects 50 through 51, wherein the first priority is based at least in part on a downlink channel associated with the one or more downlink messages, the second priority is based at least in part on an uplink channel associated with the one or more uplink messages, and the network entity determines which of the first priority and the second priority is the higher priority based at least in part on a table comparing the downlink channel and the uplink channel.

Aspect 53: The method of any of aspects 40 through 52, wherein the one or more SBFD collision rules indicate for the network entity to communicate the one or more downlink messages or the one or more uplink messages based at least in part on a channel priority order, and wherein communicating the one or more downlink messages or the one or more uplink messages comprises: communicating the one or more downlink messages or the one or more uplink messages based at least in part on the channel priority order.

Aspect 54: The method of aspect 53, wherein the one or more downlink messages are associated with a first channel and the one or more uplink messages are associated with a second channel, and wherein communicating the one or more downlink messages or the one or more uplink messages comprises: transmitting the one or more downlink messages based at least in part on the first channel being associated with a higher priority than the second channel in accordance with the channel priority order; or receiving the one or more uplink messages based at least in part on the second channel being associated with a higher priority than the first channel in accordance with the channel priority order.

Aspect 55: The method of any of aspects 53 through 54, wherein the channel priority order comprises synchronization signal blocks, random access occasions, physical downlink control channels, physical uplink control channels, physical downlink shared channels, physical uplink shared channels, channel state information reference signals, and sounding reference signals, as ordered from highest priority to lowest priority.

Aspect 56: The method of any of aspects 53 through 55, wherein the channel priority order comprises aperiodic physical random access channels, aperiodic physical uplink control channels, dynamic grant physical downlink shared channels, dynamic grant physical uplink shared channels, aperiodic channel state information reference signals, and aperiodic sounding reference signals, as ordered from highest priority to lowest priority.

Aspect 57: The method of any of aspects 40 through 56, wherein the one or more downlink messages are associated with a first transmission periodicity and the one or more uplink messages are associated with a second transmission periodicity, wherein the one or more SBFD collision rules indicate for the network entity to communicate the one or more downlink messages or the one or more uplink messages based at least in part on a comparison between the first transmission periodicity and the second transmission periodicity, and wherein communicating the one or more downlink messages or the one or more uplink messages comprises: communicating the one or more downlink messages or the one or more uplink messages based at least in part on the comparison between the first transmission periodicity and the second transmission periodicity.

Aspect 58: The method of aspect 57, wherein a semi-persistent transmission periodicity is associated with a higher priority than a periodic transmission periodicity.

Aspect 59: The method of any of aspects 40 through 58, wherein the one or more SBFD collision rules indicate for the network entity to communicate the one or more downlink messages or the one or more uplink messages based at least in part on one or more conditions associated with the UE, and wherein communicating the one or more downlink messages or the one or more uplink messages comprises: communicating the one or more downlink messages or the one or more uplink messages based at least in part on the one or more conditions associated with the UE.

Aspect 60: The method of aspect 59, wherein the one or more conditions may be based on prioritizing uplink coverage, prioritizing uplink latency, prioritizing monitoring occasions, prioritizing tracking reference signals, or any combination thereof.

Aspect 61: The method of any of aspects 40 through 60, wherein the one or more downlink messages are associated with a first channel and the one or more uplink messages are associated with a second channel, and the one or more SBFD collision rules are based at least in part on a channel pair including the first channel and the second channel.

Aspect 62: The method of any of aspects 40 through 61, wherein both the one or more downlink messages and the one or more uplink messages are dynamically scheduled, wherein the one or more downlink messages are associated with a first scheduling offset and the one or more uplink messages are associated with a second scheduling offset, and wherein communicating the one or more downlink messages or the one or more uplink messages comprises: communicating the one or more downlink messages or the one or more uplink messages based at least in part on comparisons between a threshold scheduling offset and each of the first scheduling offset and the second scheduling offset.

Aspect 63: The method of aspect 62, wherein the one or more SBFD collision rules indicate for the network entity to transmit the one or more downlink messages based at least in part on the first scheduling offset being less than the threshold scheduling offset and the second scheduling offset being greater than the threshold scheduling offset, and wherein communicating the one or more downlink messages or the one or more uplink messages comprises: transmitting the one or more downlink messages based at least in part on the first scheduling offset being less than the threshold scheduling offset and the second scheduling offset being greater than the threshold scheduling offset.

Aspect 64: The method of any of aspects 62 through 63, wherein communicating the one or more downlink messages or the one or more uplink messages in accordance with the one or more SBFD collision rules is based at least in part on both the first scheduling offset and the second scheduling offset being greater than the threshold scheduling offset.

Aspect 65: The method of any of aspects 40 through 64, wherein transmitting the one or more control messages scheduling the one or more downlink messages and the one or more uplink messages comprises: transmitting, at a first time, a first control message scheduling the one or more downlink messages; and transmitting, at a second time, a second control message scheduling the one or more uplink messages, wherein the one or more SBFD collision rules indicate for the network entity to communicate the one or more downlink messages or the one or more uplink messages based at least in part on a comparison between the first time and the second time.

Aspect 66: The method of aspect 65, wherein the one or more SBFD collision rules indicate for the network entity to communicate the one or more downlink messages or the one or more uplink messages based at least in part on a comparison between the first time and the second time, and wherein communicating the one or more downlink messages or the one or more uplink messages comprises: transmitting the one or more downlink messages based at least in part on the first time being after the second time; or receiving the one or more uplink messages based at least in part on the first time being before the second time.

Aspect 67: The method of any of aspects 40 through 66, wherein the one or more downlink messages comprise one or more downlink synchronization signal block reference signals and the one or more uplink messages are dynamically scheduled or semi-statically configured or semi-persistently configured, and wherein the one or more SBFD collision rules indicate for the network entity to transmit receive the one or more downlink messages based at least in part on the one or more downlink messages comprising the one or more downlink synchronization signal block reference signals, and wherein communicating the one or more downlink messages or the one or more uplink messages comprises: transmitting the one or more downlink synchronization signal block reference signals via the SBFD symbol based at least in part on the one or more downlink messages comprising the one or more downlink synchronization signal block reference signals

Aspect 68: The method of any of aspects 40 through 67, wherein the one or more downlink messages are dynamically scheduled or semi-statically configured or semi-persistently configured and the one or more uplink messages are associated with one or more random access occasions, and wherein the one or more SBFD collision rules indicate for the network entity to receive the one or more uplink messages based at least in part on the one or more uplink messages being associated with the one or more random access occasions, and wherein communicating the one or more downlink messages or the one or more uplink messages comprises: receiving the one or more uplink messages via the SBFD symbol based at least in part on the one or more uplink messages being associated with one or more random access occasions.

Aspect 69: The method of any of aspects 40 through 68, further comprising: transmitting a second control message indicating the one or more SBFD collision rules, wherein communicating the one or more downlink messages or the one or more uplink messages is based at least in part on receiving the second control message.

Aspect 70: The method of any of aspects 40 through 69, wherein the one or more downlink messages are dynamically scheduled or semi-statically configured or semi-persistently configured and the one or more uplink messages are associated with one or more random access occasions the one or more uplink messages are associated with one or more random access occasions further associated with a random access procedure, and the one or more SBFD collision rules are based at least in part on whether the random access procedure was triggered dynamically or was triggered by radio resource control signaling.

Aspect 71: The method of aspect 70, wherein communicating the one or more downlink messages or the one or more uplink messages comprises: receiving the one or more uplink messages via the SBFD symbol based at least in part on the random access procedure being triggered dynamically via physical downlink control channel order and based at least in part on the one or more downlink messages being semi-statically configured.

Aspect 72: The method of any of aspects 70 through 71, wherein communicating the one or more downlink messages or the one or more uplink messages comprises: transmitting the one or more downlink messages via the SBFD symbol based at least in part on the random access procedure being triggered by the radio resource control signaling and based at least in part on the one or more downlink messages being dynamically configured via downlink control information.

Aspect 73: The method of any of aspects 70 through 72, wherein the network entity does not schedule the random access procedure to be triggered dynamically via physical downlink control channel order and the one or more downlink messages to be dynamically configured via downlink control information simultaneously.

Aspect 74: The method of any of aspects 70 through 73, wherein communicating the one or more downlink messages or the one or more uplink messages in accordance with the one or more SBFD collision rules is based at least in part on the random access procedure being triggered by the radio resource control signaling and based at least in part on the one or more downlink messages being semi-statically configured.

Aspect 75: The method of any of aspects 40 through 74, wherein both the one or more downlink messages and the one or more uplink messages are semi-statically configured.

Aspect 76: The method of any of aspects 40 through 75, wherein both the one or more downlink messages and the one or more uplink messages are dynamically scheduled.

Aspect 77: The method of any of aspects 40 through 76, wherein the one or more downlink messages comprise one or more synchronization signal block reference signals and the one or more uplink messages are dynamically scheduled or semi-statically configured or semi-persistently configured.

Aspect 78: The method of any of aspects 40 through 77, wherein the one or more downlink messages are dynamically scheduled or semi-statically configured or semi-persistently configured and the one or more uplink messages are associated with one or more random access occasions.

Aspect 79: A half-duplex UE for wireless communications, comprising one or more memories storing processor-executable code, and one or more processors coupled with the one or more memories and individually or collectively operable to execute the code to cause the half-duplex UE to perform a method of any of aspects 1 through 39.

Aspect 80: A half-duplex UE for wireless communications, comprising at least one means for performing a method of any of aspects 1 through 39.

Aspect 81: A non-transitory computer-readable medium storing code for wireless communications, the code comprising instructions executable by one or more processors to perform a method of any of aspects 1 through 39.

Aspect 82: A network entity for wireless communications, comprising one or more memories storing processor-executable code, and one or more processors coupled with the one or more memories and individually or collectively operable to execute the code to cause the network entity to perform a method of any of aspects 40 through 78.

Aspect 83: A network entity for wireless communications, comprising at least one means for performing a method of any of aspects 40 through 78.

Aspect 84: A non-transitory computer-readable medium storing code for wireless communications, the code comprising instructions executable by one or more processors to perform a method of any of aspects 40 through 78.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A half-duplex user equipment (UE), comprising:
one or more memories storing processor-executable code; and
one or more processors coupled with the one or more memories and individually or collectively operable to execute the code to cause the half-duplex UE to:
receive a configuration message indicating one or more sub-band full-duplex (SBFD) symbols for a network entity, wherein each SBFD symbol of the one or more SBFD symbols comprises one or more uplink sub-bands and one or more downlink sub-bands;
receive one or more control messages scheduling one or more downlink messages during a SBFD symbol of the one or more SBFD symbols and scheduling one or more uplink messages during the SBFD symbol of the one or more SBFD symbols, wherein the one or more downlink messages at least partially overlap the one or more uplink messages in time; and
communicate, via the SBFD symbol, the one or more downlink messages or the one or more uplink messages in accordance with one or more SBFD collision rules.

2. The half-duplex UE of claim 1, wherein, to communicate the one or more downlink messages or the one or more uplink messages, the one or more processors are individually or collectively operable to execute the code to cause the half-duplex UE to:
receive the one or more downlink messages based at least in part on the one or more SBFD collision rules indicating for the UE to prioritize the one or more downlink messages; or
transmit the one or more uplink messages based at least in part on the one or more SBFD collision rules indicating for the UE to prioritize the one or more uplink messages.

3. The half-duplex UE of claim 1, wherein the one or more SBFD collision rules indicate for the UE to transmit the one or more uplink messages based at least in part on whether the SBFD symbol is configured on a downlink symbol or on a flexible symbol, and wherein, to communicate the one or more downlink messages or the one or more uplink messages, the one or more processors are individually or collectively operable to execute the code to cause the half-duplex UE to:
communicate the one or more downlink messages or the one or more uplink messages based at least in part on whether the SBFD symbol is configured on the downlink symbol or on the flexible symbol.

4. The half-duplex UE of claim 3, wherein, to communicate the one or more downlink messages or the one or more uplink messages, the one or more processors are individually or collectively operable to execute the code to cause the half-duplex UE to:
receive the one or more downlink messages based at least in part on the SBFD symbol being configured on the downlink symbol; or
transmit the one or more uplink messages based at least in part on the SBFD symbol being configured on the flexible symbol.

5. The half-duplex UE of claim 1, wherein the one or more SBFD collision rules indicate for the UE to communicate the one or more downlink messages or the one or more uplink messages based at least in part on whether the one or more downlink messages or the one or more uplink messages comprises a flag, and wherein, to communicate the one or more downlink messages or the one or more uplink messages, the one or more processors are individually or collectively operable to execute the code to cause the half-duplex UE to:
communicate the one or more downlink messages or the one or more uplink messages based at least in part on whether the one or more downlink messages or the one or more uplink messages comprises the flag.

6. The half-duplex UE of claim 5, wherein, to communicate the one or more downlink messages or the one or more uplink messages, the one or more processors are individually or collectively operable to execute the code to cause the half-duplex UE to:
receive the one or more downlink messages based at least in part on the one or more downlink messages comprising the flag; or
transmit the one or more uplink messages based at least in part on the one or more uplink messages comprising the flag.

7. The half-duplex UE of claim 1, wherein the one or more SBFD collision rules indicate for the UE to communicate the one or more downlink messages or the one or more uplink messages based at least in part on whether the one or more downlink messages or the one or more uplink messages are associated with a higher priority, and wherein, to communicate the one or more downlink messages or the one or more uplink messages, the one or more processors are individually or collectively operable to execute the code to cause the half-duplex UE to:
communicate the one or more downlink messages or the one or more uplink messages based at least in part on whether the one or more downlink messages or the one or more uplink messages are associated with the higher priority.

8. The half-duplex UE of claim 1, wherein the one or more SBFD collision rules indicate for the UE to communicate the one or more downlink messages or the one or more uplink messages based at least in part on a channel priority order, and wherein, to communicate the one or more downlink messages or the one or more uplink messages, the one or more processors are individually or collectively operable to execute the code to cause the half-duplex UE to:
communicate the one or more downlink messages or the one or more uplink messages based at least in part on the channel priority order.

9. The half-duplex UE of claim 1, wherein the one or more downlink messages are associated with a first transmission periodicity and the one or more uplink messages are associated with a second transmission periodicity, wherein the one or more SBFD collision rules indicate for the UE to communicate the one or more downlink messages or the one or more uplink messages based at least in part on a comparison between the first transmission periodicity and the second transmission periodicity, and wherein, to communicate the one or more downlink messages or the one or more uplink messages, the one or more processors are individually or collectively operable to execute the code to cause the half-duplex UE to:
communicate the one or more downlink messages or the one or more uplink messages based at least in part on the comparison between the first transmission periodicity and the second transmission periodicity.

10. The half-duplex UE of claim 9, wherein a semi-persistent transmission periodicity is associated with a higher priority than a periodic transmission periodicity.

11. The half-duplex UE of claim 1, wherein the one or more SBFD collision rules indicate for the UE to communicate the one or more downlink messages or the one or more uplink messages based at least in part on one or more conditions associated with the UE, and wherein, to communicate the one or more downlink messages or the one or more uplink messages, the one or more processors are individually or collectively operable to execute the code to cause the half-duplex UE to:
communicate the one or more downlink messages or the one or more uplink messages based at least in part on the one or more conditions associated with the UE.

12. The half-duplex UE of claim 1, wherein the one or more downlink messages are associated with a first channel and the one or more uplink messages are associated with a second channel, and wherein the one or more SBFD collision rules are based at least in part on a channel pair including the first channel and the second channel.

13. The half-duplex UE of claim 1, wherein both the one or more downlink messages and the one or more uplink messages are dynamically scheduled, wherein the one or more downlink messages are associated with a first scheduling offset and the one or more uplink messages are associated with a second scheduling offset, and wherein, to communicate the one or more downlink messages or the one or more uplink messages, the one or more processors are individually or collectively operable to execute the code to cause the half-duplex UE to:
communicate the one or more downlink messages or the one or more uplink messages based at least in part on comparisons between a threshold scheduling offset and each of the first scheduling offset and the second scheduling offset.

14. The half-duplex UE of claim 13, wherein the one or more SBFD collision rules indicate for the UE to receive the one or more downlink messages based at least in part on the first scheduling offset being less than the threshold scheduling offset and the second scheduling offset being greater than the threshold scheduling offset, and wherein, to communicate the one or more downlink messages or the one or more uplink messages, the one or more processors are individually or collectively operable to execute the code to cause the half-duplex UE to:
receive the one or more downlink messages based at least in part on the first scheduling offset being less than the threshold scheduling offset and the second scheduling offset being greater than the threshold scheduling offset.

15. The half-duplex UE of claim 13, wherein communicating the one or more downlink messages or the one or more uplink messages in accordance with the one or more SBFD collision rules is based at least in part on both the first scheduling offset and the second scheduling offset being greater than the threshold scheduling offset.

16. The half-duplex UE of claim 1, wherein, to receive the one or more control messages scheduling the one or more downlink messages and the one or more uplink messages, the one or more processors are individually or collectively operable to execute the code to cause the half-duplex UE to:
receive, at a first time, a first control message scheduling the one or more downlink messages; and
receive, at a second time, a second control message scheduling the one or more uplink messages, wherein the one or more SBFD collision rules indicate for the UE to communicate the one or more downlink messages or the one or more uplink messages based at least in part on a comparison between the first time and the second time.

17. The half-duplex UE of claim 1, wherein the one or more processors are individually or collectively further operable to execute the code to cause the half-duplex UE to:
receive a second control message indicating the one or more SBFD collision rules, wherein communicating the one or more downlink messages or the one or more uplink messages is based at least in part on receiving the second control message.

18. The half-duplex UE of claim 1, wherein the one or more downlink messages are dynamically scheduled or semi-statically configured or semi-persistently configured and the one or more uplink messages are associated with one or more random access occasions further associated with a random access procedure, and wherein the one or more SBFD collision rules are based at least in part on whether the random access procedure was triggered dynamically or was triggered by radio resource control signaling.

19. A method for wireless communications at a half-duplex user equipment (UE), comprising:
receive a configuration message indicating one or more sub-band full-duplex (SBFD) symbols for a network entity, wherein each SBFD symbol of the one or more SBFD symbols comprises one or more uplink sub-bands and one or more downlink sub-bands;
receiving one or more control messages scheduling one or more downlink messages during a SBFD symbol of the one or more SBFD symbols and scheduling one or more uplink messages during the SBFD symbol of the one or more SBFD symbols, wherein the one or more downlink messages at least partially overlap the one or more uplink messages in time; and
communicating, via the SBFD symbol, the one or more downlink messages or the one or more uplink messages in accordance with one or more SBFD collision rules.

20. A half-duplex user equipment (UE) for wireless communications, comprising:
means for receive a configuration message indicating one or more sub-band full-duplex (SBFD) symbols for a network entity, wherein each SBFD symbol of the one or more SBFD symbols comprises one or more uplink sub-bands and one or more downlink sub-bands;
means for receiving one or more control messages scheduling one or more downlink messages during a SBFD symbol of the one or more SBFD symbols and scheduling one or more uplink messages during the SBFD symbol of the one or more SBFD symbols, wherein the one or more downlink messages at least partially overlap the one or more uplink messages in time; and
means for communicating, via the SBFD symbol, the one or more downlink messages or the one or more uplink messages in accordance with one or more SBFD collision rules.
